(19) United States
(12) Patent Application Publication
(10) Pub. No.: US 2021/0088173 A1
(43) Pub. Date: Mar. 25, 2021

(54) VACUUM INSULATED ARTICLES WITH REFLECTIVE MATERIAL ENHANCEMENT

(71) Applicant: CONCEPT GROUP LLC, Wellesley, MA (US)

(72) Inventors: Shriram RADHAKRISHNAN, West Palm Beach, FL (US); Aarne H. REID, Jupiter, FL (US); David H. REID, Jr., Fort Pierce, FL (US)

(21) Appl. No.: 16/630,010

(22) PCT Filed: Jul. 12, 2018
(86) PCT No.: PCT/US18/41848

§ 371 Date: Jan. 10, 2020

Related U.S. Application Data
(60) Provisional application No. 62/531,494, filed on Jul. 12, 2017.
(60) Provisional application No. 62/581,966, filed on Nov. 6, 2017.

(51) Int. Cl. F16L 59/065; B32B 5/02

(52) U.S. Cl. CPC F16L 59/065; F17C 3/08; B32B 5/022

(57) ABSTRACT

Provided are vacuum-insulated articles that comprise an evacuated space disposed between first and second walls and a reflective material disposed within the evacuated space. Also provided are methods of fabricating such articles.

### RELATED APPLICATIONS

The present application claims priority to and the benefit of U.S. Patent Application 62/531,494, “Vacuum Insulated Articles With Reflective Material Enhancement” (filed Jul. 12, 2017) and U.S. Patent Application 62/581,966, “Vacuum Insulated Structures Comprising Ceramic Materials” (filed Nov. 6, 2017). Each of the foregoing applications is incorporated herein by reference in its entirety for any and all purposes.

### TECHNICAL FIELD

The present disclosure relates to the field of vacuum insulated articles.

### BACKGROUND

Vacuum-insulated articles have application to a number of fields, including electronics and energy storage applications. In some applications—e.g., energy storage or energy retention applications—that operate under extreme conditions, improved insulating performance is desirable. Accordingly, there is a need in the art for improved vacuum-insulated articles and related methods of manufacturing such articles.

### SUMMARY

In meeting these needs, the present disclosure provides vacuum-insulated articles, comprising: a first wall and a second wall; a first sealed insulating space formed between the first wall and the second wall, the insulating space defining therein a region of reduced pressure; a first vent communicating with the first insulating space to provide an exit pathway for gas molecules from the first insulating space, the first vent being sealable for maintaining a first vacuum within the first insulating space following evacuation of gas molecules through the first vent; a first seal sealing the first insulating space at the first vent; and at least one portion of a reflective material having a surface, the at least one portion of reflective material being disposed within the insulating space, the surface of the reflective material comprising boron nitride.

The present disclosure also provides articles, comprising: first and second walls defining a sealed vacuum space disposed therebetween; and at least one portion of a reflective material disposed within the sealed vacuum space, the surface of the reflective material comprising boron nitride.

Additionally disclosed are electronics components, the components comprising an article according to the present disclosure.

Further provided are methods, the methods comprising disposing at least one portion of a reflective material in a space between two walls, the surface of the reflective material comprising boron nitride; and giving rise to a sealed vacuum within said space.

Also disclosed are vacuum-insulated vessels, comprising: a first wall and an second wall defining an first insulating space of reduced pressure disposed between the first and second walls; the second wall enclosing the first wall and the first wall enclosing and defining a storage volume; a first conduit disposed so as to place the storage volume into fluid communication with the environment exterior to the vessel; and a first vent communicating with the first insulating space to provide an exit pathway for gas molecules from the first insulating space, the first vent being sealable for maintaining a first vacuum within the first insulating space following evacuation of gas molecules through the first vent; a first seal sealing the first insulating space at the first vent; and at least one portion of reflective material disposed within the first insulating space, the surface of the reflective material comprising boron nitride.

Additionally provided are methods, comprising disposing an amount of a fluid into the storage volume of a vessel according to the present disclosure.

Further provided are methods, comprising removing an amount of a fluid from the storage volume of a vessel according to the present disclosure.

Also provided are methods, the methods comprising removing an amount of a fluid from the spillover volume of a vessel according to the present disclosure.

In meeting the long-felt needs described above, the present disclosure first provides insulated articles comprising: a first wall bounding an interior volume; a second wall spaced at a distance from the first wall to define an insulating space therebetween, at least one of the first and second walls comprising a ceramic material; and a vent communicating with the insulating space to provide an exit pathway for gas molecules from the space, the vent being sealable for maintaining a vacuum within the insulating space following evacuation of gas molecules through the vent, the distance between the first and second walls being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress. (In some embodiments, the first wall is a metal and the second wall is a ceramic. In some embodiments, the first wall is a ceramic and the second wall is a metal. In some embodiments, both walls are metal; in other embodiments, both walls are ceramic.)

In another aspect, the present disclosure provides methods of insulating an article, comprising: with first and second walls spaced at a distance from each other to define an insulating space therebetween, the distance between the walls being variable in a portion of the insulating space, at least one of the first and second walls comprising a ceramic material, and with a vent in communication with the insulating space to provide an exit pathway for gas molecules from the insulating space, the vent located proximate to the variable distance portion of the insulating space such that gas molecules are guided towards the vent during evacuation of the insulating space to facilitate their egress from the insulating space, and the vent being sealable for maintaining a vacuum within the insulating space; subjecting an exterior of the first and second walls to a vacuum to evacuate the insulating space, the facilitated egress of gas molecules provided by the variable distance portion of the insulating space increasing the probability of gas molecule egress from the space rather than ingress such that a deeper vacuum is generated within the insulating space than the vacuum to which the exterior is subjected; and sealing the vent to maintain the deeper vacuum within the space.

Further provided herein are cooling devices, comprising: an outer jacket including a substantially cylindrical first portion and a substantially semi-spherical second portion; a first tube received by the first portion of the outer jacket and located substantially concentric thereto to define an insulating space therebetween, at least one end of the first tube forming a sealable vent with an inner surface of the outer jacket for maintaining a vacuum within the insulating space following evacuation of gas molecules through the vent, the distance between the first tube and the inner surface of the outer jacket being variable in a portion of the insulating space adjacent the vent such that gas molecules within the insulating space are directed towards the vent by the variable-distance portion during evacuation of the insulating space, thereby imparting to the gas molecules a greater probability of egress from the insulating space than ingress; and a second tube received by the first tube and located substantially concentric thereto to define a gas inlet therebetween, at least one of the first tube, the second tube, and the outer jacket comprising a ceramic material.

In meeting the described long-felt needs, the present disclosure provides insulated conduits, comprising: an outer tube having a first end and an inner tube having a first end, the inner tube defining a lumen, the inner tube being disposed within the outer tube so as to define a insulating space between the first tube and the second tube, the conduit further comprising a vent defined by a sealer ring having a first wall and a second wall, the second wall being disposed opposite the outer tube and the first wall being disposed opposite the inner tube, the sealer ring being disposed between one or both of the first end of the outer tube and the first end of the inner tube and the other tube so as to seal the insulating space to provide an exit pathway for gas molecules from the space, the vent being sealable for maintaining a vacuum within the insulating space following evacuation of gas molecules through the vent, (a) the distance between the second wall of the sealer ring and the outer tube and/or (b) the distance between the first wall of the sealer ring and the and the outer tube being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress, and the lumen of the inner tube comprising a first major axis at the first end of the inner tube, and the lumen comprising a bend, measured relative to the first major axis of from about 1 to about 180 degrees.

The present disclosure also provides methods, the methods comprising communicating a fluid through an insulated conduit according to the present disclosure.

The present disclosure also provides methods of installing a heated element within the lumen of the present invention according to the present disclosure. As one example, a heater (e.g., a wire) can be at least partially enclosed within the lumen of an article according to the present disclosure.

The present disclosure also provides methods of comprising installing a heated element in proximity to the outer wall of an article according to the present disclosure. As an example, an article according to the present disclosure can be used to enclose a conduit that carries a cool fluid, with the article being positioned so as to shield the conduit from a source of thermal radiation, e.g., a hot exhaust pipe.

Also provided are methods, comprising: positioning an inner tube having a first end within an outer tube having a first end, so as to define an insulating space therebetween; positioning a spacer in the insulating space; sealing, to the inner tube and outer tube, a sealer ring having a first wall and a second wall so as to form a vent, the second wall of the sealer ring being disposed opposite the outer tube and the first wall of the sealer ring being disposed opposite the inner tube, the sealer ring being disposed between one or both of the first end of the outer tube and the first end of the inner tube and the other tube so as to seal the insulating space to provide an exit pathway for gas molecules from the space, the vent being sealable for maintaining a vacuum within the insulating space following evacuation of gas molecules through the vent, (a) the distance between the second wall of the sealer ring and the outer tube and/or (b) the distance between the first wall of the sealer ring and the and the outer tube being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress, and the lumen of the inner tube comprising a first major axis at the first end of the inner tube.

Further provided are insulated conduits, comprising: a corrugated outer tube having a first end; an inner tube having a first end, the inner tube defining a lumen, the inner tube being disposed within the outer tube so as to define a insulating space between the first tube and the second tube, the conduit further comprising a vent defined by a seal between the outer tube and the inner tube, the vent being sealable for maintaining a vacuum within the insulating space following evacuation of gas molecules through the vent, the distance between the inner tube and the outer tube being variable in a portion of the insulating space adjacent the vent such that gas molecules within the insulating space are directed towards the vent by the variable-distance portion, the directing of the gas molecules by the variable-distance portion imparting to the gas molecules a greater probability of egress from the insulating space than ingress, and the lumen of the inner tube comprising a first major axis at the first end of the inner tube, and the lumen comprising a bend, measured relative to the first major axis, of from about 1 to about 180 degrees.

The present disclosure also provides methods, the methods comprising communicating a fluid through an insulated conduit according to the present disclosure (e.g., Embodiments 31-46).

Further provided are methods, comprising: positioning an inner tube having a first end within a corrugated outer tube having a first end, so as to define an insulating space therebetween; (a) the outer tube comprising a region that converges toward the inner tube, (b) the inner tube comprising a region that diverges toward the outer tube, or both (a) and (b), positioning a spacer in the insulating space; sealing the outer tube and inner tube to one another so as to form a vent, the vent being sealable for maintaining a vacuum within the insulating space following evacuation of gas molecules through the vent, the distance between the inner tube and the outer tube being variable in a portion of the insulating space adjacent the vent such that gas molecules within the insulating space are directed towards the vent by the variable-distance portion, the directing of the gas molecules by the variable-distance portion imparting to the gas molecules a greater probability of egress from the insulating space than ingress, and the lumen of the inner tube comprising a first major axis at the first end of the inner tube, and the lumen of the inner tube comprising a first major axis at the first end of the inner tube, the lumen comprising a bend, measured relative to the first major axis, of from about 1 to about 180 degrees.

Also provided are insulated conduits, comprising: an outer tube having a first end and an inner tube having a first end, the inner tube defining a lumen, the first end of the inner tube and the first end of the outer tube being sealed to one another so as to define a insulating space between the first tube and the second tube, the distance between the inner and outer tubes being variable in a portion of the insulating space, and a vent in communication with the insulating space to provide an exit pathway for gas molecules from the insulating space, the vent located proximate to the variable distance portion of the insulating space such that gas molecules are guided towards the vent during evacuation of the insulating space to facilitate their egress from the insulating space, and the vent being sealable for maintaining a vacuum within the insulating space; the distance between the inner and outer tubes being variable in a portion of the insulating space adjacent the vent such that gas molecules within the insulating space are directed towards the vent by the variable-distance portion, the directing of the gas molecules by the variable-distance portion imparting to the gas molecules a greater probability of egress from the insulating space than ingress, and the lumen of the inner tube comprising a first major axis at the first end of the inner tube, and the lumen comprising a bend, measured relative to the first major axis of from about 1 to about 180 degrees.

Additionally provided are insulated conduits, comprising: an outer tube; an inner tube disposed within the outer tube, the inner tube defining a lumen, and the inner tube being disposed within the outer tube so as to define a insulating space between the inner tube and the outer tube; a sealer ring having a first wall and a second wall, the second wall being disposed opposite the outer tube and the first wall being disposed opposite the inner tube, the sealer ring comprising a ceramic material, the sealer ring being disposed between the outer tube and the inner tube so as to seal the insulating space to provide an exit pathway for gas molecules from the space, the lumen of the inner tube comprising a first major axis at a first end of the inner tube, and the lumen optionally comprising a bend, measured relative to the first major axis of from about 1 to about 180 degrees.

The present disclosure also provides devices having an inner wall and an outer wall and comprising a ceramic material, the device being configured so as to minimize heat transfer between the inner wall and the outer wall according to the present disclosure.

The ceramic material can contain a second material, e.g., mica, that can enhance the restriction of thermal transfer between the inner wall and the outer wall according to the present disclosure. The ceramic material can act as a restriction point for the transfer of thermal energy between the inner wall and the outer wall according to the present disclosure.

The ceramic material can also be configured so as to create a comparatively longer heat path so as to restrict the thermal transfer between the inner wall and the outer wall according to the present disclosure.

Also disclosed are methods, comprising: positioning an inner tube within an outer so as to define an insulating space therebetween; optionally positioning a spacer in the insulating space; positioning a sealer ring having a first wall and a second wall so as to form a vent to the insulating space, the sealer ring comprising a ceramic material, the second wall of the sealer ring being disposed opposite the outer tube and the first wall of the sealer ring being disposed opposite the inner tube, the sealer ring being disposed so as to seal the insulating space to provide an exit pathway for gas molecules from the space, the vent being sealable for maintaining a vacuum within the insulating space following evacuation of gas molecules through the vent, and the lumen of the inner tube comprising a first major axis at the first end of the inner tube.

The present disclosure also provides insulated modules, comprising: a first boundary; a second boundary; the first boundary and the second boundary being disposed so as to define a insulating space between the first boundary and second boundary; a sealer element having a first wall and a second wall, the second wall being disposed opposite the second boundary and the first wall being disposed opposite the first boundary, the sealer element comprising a ceramic material, the sealer element being disposed between the first boundary and the second boundary so as to seal the insulating space to provide an exit pathway for gas molecules from the insulating space.

Further provided are vacuum-insulated articles, comprising: a first wall having a first thermal conductivity; a second wall having a second thermal conductivity; a first sealed insulating space formed between the first wall and the second wall, the insulating space defining therein a region of reduced pressure, the first sealed insulating space being at least partially defined by a bridge material that has a thermal conductivity that is less than the first thermal conductivity and the second thermal conductivity; optionally, a reflective material disposed within the first sealed insulating space, the reflective material optionally comprising boron nitride.

Additionally disclosed are articles, comprising: (a) an outer wall; (b) an inner wall; (c) a first sealed insulating space formed between the outer wall and the inner wall, at least one of the outer and inner walls having a sloped region that slopes toward the other wall, the sloped region at least partially defining the first sealed insulating space, the at least one wall having the sloped region further comprising a joint land connected to and extending from the sloped region, and the joint land forming a non-zero angle with the sloped region.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 depicts a cutaway view of an exemplary vessel;

FIG. 2 depicts a cutaway view of an alternative exemplary vessel;

FIG. 3 depicts a cutaway view of an alternative exemplary vessel;

FIG. 4 depicts a cutaway view of an alternative exemplary vessel;

FIG. 5A depicts an exterior and cutaway view of an exemplary article;

FIG. 5B depicts an exemplary cross-section of the exemplary article of FIG. 5A;

FIG. 6A provides a cutaway view of an exemplary article;

FIG. 6B provides a magnified view of a section of the article of FIG. 6A;

FIG. 7 provides a cutaway view of an exemplary article; and

FIG. 8 provides a view of an exemplary reflective material, in fabric form.

FIG. 9 is a partial sectional view of a structure incorporating an insulating space according to the invention.

FIG. 10 is a sectional view of another structure according to the invention.

FIG. 11 is a sectional view of an alternative structure to that of FIG. 2 including a layer of spacer material on a surface of the insulation space.

FIG. 12 is a partial sectional view of a cooling device according to the invention.

FIG. 13 is a partial perspective view, in section, of an alternative cooling device according to the invention.

FIG. 14 is a partial perspective view, in section, of an end of the cooling device of FIG. 5 including an expansion chamber.

FIG. 15 is a partial sectional view of a cooling device having an alternative gas inlet construction from the cooling devices of FIGS. 4 through 6

FIG. 16 is a partial perspective view, in section, of a container according to the invention.

FIG. 17 is a perspective view, in section, of a Dewar according to the invention.

FIG. 18 provides a cutaway view of an embodiment of the disclosed technology.

FIG. 19A provides an exterior view of a conduit according to the present disclosure;

FIG. 19B provides a view of an end of an conduit according to the present disclosure;

FIG. 19C provides a magnified view of region R in FIG. 1B;

FIG. 20A provides a cutaway view of an alternative embodiment of the disclosed articles;

FIG. 20B provides a magnified view of region R in FIG. 2A;

FIG. 21 provides a cutaway view of a further illustrative embodiment of the disclosed technology;

FIG. 22A provides a cutaway view of an illustrative embodiment of the disclosed technology;

FIG. 22B provides a magnified view of region 410 of FIG. 4A;

FIG. 23 provides a cutaway view of an illustrative embodiment of the disclosed technology;

FIG. 24 provides a cutaway view of an illustrative embodiment of the disclosed technology;

FIG. 25 provides a cutaway view of an illustrative embodiment of the disclosed technology;

FIG. 26 provides a cutaway view of an illustrative embodiment of the disclosed technology;

FIG. 27 provides a cutaway view of an illustrative embodiment of the disclosed technology; and

FIG. 28 provides a cutaway view of an illustrative embodiment of the disclosed technology.

### DETAILED DESCRIPTION OF ILLUSTRATIVE EMBODIMENTS

The present invention can be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable, and it should be understood that steps can be performed in any order.

It is to be appreciated that certain features of the invention which are, for clarity, described herein in the context of separate embodiments, can also be provided in combination in a single embodiment. Conversely, various features of the invention that are, for brevity, described in the context of a single embodiment, can also be provided separately or in any subcombination. Further, reference to values stated in ranges include each and every value within that range. In addition, the term “comprising” should be understood as having its standard, open-ended meaning, but also as encompassing “consisting” as well. For example, a device that comprises Part A and Part B can include parts in addition to Part A and Part B, but can also be formed only from Part A and Part B.

In one aspect, the present disclosure provides vacuum-insulated articles that comprise a first insulating space formed between two walls. An article can include a first vent communicating with the first insulating space to provide an exit pathway for gas molecules from the first insulating space, the first vent being sealable for maintaining a first vacuum within the first insulating space following evacuation of gas molecules through the first vent; and a first seal sealing the first insulating space at the first vent. As described elsewhere herein, the articles can include at least one portion of a reflective material having a surface, the at least one portion of reflective material being disposed within the insulating space, the surface of the reflective material comprising boron nitride.

The insulating space can be evacuated, e.g., a vacuum space. Some exemplary vacuum-insulated structures (and related techniques for forming and using such structures) can be found in United States published patent applications 2015/0110548, 2014/0090737, 2012/0090817, 2011/0264084, 2008/0121642, and 2005/0211711, all by A. Reid, and all incorporated herein by reference in their entireties for any and all purposes.

As explained in U.S. Pat. Nos. 7,681,299 and 7,374,063 (incorporated herein by reference in their entireties for any and all purposes), the geometry of the insulating space can be such that it guides gas molecules within the space toward a vent or other exit from the space. The width of the vacuum insulating space need not be not uniform throughout the length of the space. The space can include an angled portion such that one surface that defines the space converges toward another surface that defines the space. As a result, the distance separating the surfaces can vary adjacent the vent such the distance is at a minimum adjacent the location at which the vent communicates with the vacuum space. The interaction between gas molecules and the variable-distance portion during conditions of low molecule concentration serves to direct the gas molecules toward the vent.

The molecule-guiding geometry of the space provides for a deeper vacuum to be sealed within the space than that which is imposed on the exterior of the structure to evacuate the space. This somewhat counterintuitive result of deeper vacuum within the space is achieved because the geometry of the present invention significantly increases the probability that a gas molecule will leave the space rather than enter. In effect, the geometry of the insulating space functions like a check valve to facilitate free passage of gas molecules in one direction (via the exit pathway defined by vent) while blocking passage in the opposite direction.

Another benefit associated with the deeper vacuums provided by the geometry of insulating space is that it is achievable without the need for a getter material to capture molecules within the space formed by the walls. The ability to develop such deep vacuums without a getter material provides for deeper vacuums in devices of miniature scale and devices having insulating spaces of narrow width where space constraints would limit the use of a getter material. Further, because some getter materials will release molecules when the getter reaches a certain temperature, the ability to develop such deep vacuums without a getter material provides for deeper vacuums that can be maintained at temperatures above the release point of the getter material.

Other vacuum-enhancing features can also be included, such as low-emissivity coatings on the surfaces that define the vacuum space. The reflective surfaces of such coatings, generally known in the art, tend to reflect heat-transferring rays of radiant energy. Limiting passage of the radiant energy through the coated surface enhances the insulating effect of the vacuum space.

In some embodiments, an article can comprise first and second walls spaced at a distance to define an insulating space therebetween and a vent communicating with the insulating space to provide an exit pathway for gas molecules from the insulating space. The vent is sealable for maintaining a vacuum within the insulating space following evacuation of gas molecules through the vent. The distance between the first and second walls is variable in a portion of the insulating space adjacent the vent such that gas molecules within the insulating space are directed towards the vent during evacuation of the insulating space. The direction of the gas molecules towards the vent imparts to the gas molecules a greater probability of egress than ingress with respect to the insulating space, thereby providing a deeper vacuum without requiring a getter material in the insulating space.

The construction of structures having gas molecule guiding geometry according to the present invention is not limited to any particular category of materials. Suitable materials for forming structures incorporating insulating spaces according to the present invention include, for example, metals, ceramics, metalloids, or combinations thereof.

The convergence of the space provides guidance of molecules in the following manner. When the gas molecule concentration becomes sufficiently low during evacuation of the space such that structure geometry becomes a first order effect, the converging walls of the variable distance portion of the space channel gas molecules in the space toward the vent. The geometry of the converging wall portion of the vacuum space functions like a check valve or diode because the probability that a gas molecule will leave the space, rather than enter, is greatly increased.

The effect that the molecule-guiding geometry of structure has on the relative probabilities of molecule egress versus entry can be understood by analogizing the converging-wall portion of the vacuum space to a funnel that is confronting a flow of particles. Depending on the orientation of the funnel with respect to the particle flow, the number of particles passing through the funnel would vary greatly. It is clear that a greater number of particles will pass through the funnel when the funnel is oriented such that the particle flow first contacts the converging surfaces of the funnel inlet rather than the funnel outlet.

The present disclosure also provides a funnel effect (that can direct molecules out of a space between two achieved by forming a shaped groove, or grooves, in the sealing ring defined according to the present disclosure. The present disclosure also provides the funnel effect can be created by forming a shaped slit in the sealing ring defined according to the present disclosure.

The present disclosure also provides the funnel effect can be created by forming a pattern into the sealing ring that acts to promote the funnel effect defined according to the present disclosure.

The present disclosure also provides the funnel effect can be created by forming a pattern into the one or both of the inner and/or outer wall that acts to promote the funnel effect defined according to the present disclosure.

Various examples of devices incorporating a converging wall exit geometry for an insulating space to guide gas particles from the space like a funnel are provided herein. It should be understood that the gas guiding geometry of the invention is not limited to a converging-wall funneling construction and can, instead, utilize other forms of gas molecule guiding geometries. This in turn provides the ability to develop such deep vacuums without a getter material provides for deeper vacuums.

A vacuum insulated article can include an outer (e.g., second) wall and inner (e.g., first) wall, the volume between the walls forming a first insulating space. (As described elsewhere herein, the insulating space can be sealed against the environment exterior to the insulating space.)

The article can include a first circular ring arranged between the inner (e.g., first) wall and the outer (e.g., second) wall, the first circular ring having a first beveled edge circularly arranged around the first circular ring facing at least one of the inner (first) wall and the outer (second) wall, and a first vent formed at the first beveled edge communicating with the first insulating space. The vacuum insulated article can further include a first circular insulation seal sealing the first insulating space at the first vent. Further discussion of this exemplary structure can be found in United States published patent application no. 2015/0260332, the entirety of which is incorporated herein by reference for any and all purposes.

It should be understood that a vacuum (i.e., any vacuum within the disclosed devices and methods) can be effected by the methods in the aforementioned applications or by any other method known in the art.

An insulating space can have a pressure of, e.g., from less than about 760 Torr to about 1×10⁻⁷ Torr. Pressures of about 10⁻¹, 10⁻², 10⁻³, 10⁻⁴, 10⁻⁵, 10⁻⁶, and about 10⁻⁷ Torr are all considered suitable. An insulating space can be oxide-free or substantially oxide-free. Materials disposed within an insulating space can be oxide-free or substantially oxide-free.

An article according to the present disclosure can be formed from materials selected such that the article maintains its shape and integrity at up to about 2500 deg. F., up to about 2400 deg. F., up to about 2300 deg. F., up to about 2200 deg. F., up to about 2100 deg. F., or even up to about 2000 deg. F.

The walls of an article can be arranged in a concentric fashion, e.g., inner (first) and outer (second) tubes. Tubes can be circular in cross section, but a tube can also be eccentric, polygonal, or otherwise shaped in cross-section. The tubes can have the same cross-sectional shape, but can also differ in cross-sectional shape. As explained elsewhere herein, the insulating space between the inner (first) and outer (second) walls can be of a constant cross-section, but can also be of a varying cross section.

Walls can also be flat, curved, or otherwise shaped. One wall can be flat and the other wall can be curved. Walls can be cylindrical in shape, but can also be cupped, domed, dimpled, or otherwise shaped, e.g., to form the cap or bottom of a cylindrical article. An article can be planar, curved, spherical, cubic, capsule-shaped, polygonal, cylindrical, or otherwise shaped according to the needs of a user.

The at least one portion of reflective material can be characterized as being a sheet in form. The reflective material can be rectangular or square in shape, but can also be a ribbon or strip in shape, e.g., with an aspect ratio greater than 1, e.g., 2, 3, 4, 5, 6, 7, 8, 9, 10. The reflective material can be wound in a spiral fashion so as to present multiple layers into the space between the first and second walls. Alternatively, the reflective material can be present as multiple, separate portions, e.g., multiple sheets.

The reflective material can, in some embodiments, be present as a fabric. It should be understood that the term “fabric” refers to woven materials, but can also refer to non-woven materials as well. “Fabric” also includes fibers (i.e., assemblages or twists of threads) as well as to individual threads. For example, a single thread wound helically on the outer surface of a tube would be considered to be a fabric. Thus, the present disclosure includes articles having a woven material disposed in a space between two walls; a non-woven material disposed in the space between two walls, a fiber disposed in the space; a single thread disposed in the space; or any combination thereof.

An article according to the present disclosure can include one or more layers separated by spacers; exemplary embodiments are described elsewhere herein in further detail. It should be understood that the spacer material can be disposed between portions of reflective material (e.g., between adjacent sheets of reflective material). Spacer material can also be disposed between a wall of an article and a portion of reflective material so as to reduce or prevent physical contact between the wall and the reflective material.

The present disclosure also provides the spacer material can comprise a material that provides increased thermal insulation between the reflective material and other layers of reflective material or in between the reflective material and the inner or outer wall according to the present disclosure. Some non-limiting examples of such material are multi porous materials (MPI), ceramics, aerogels, meshes, and the like.

A spacer material can be flat in profile (e.g., a strip having flat or smooth upper and lower surfaces), but can also be non-flat in profile. As an example, a spacer material can have a surface pattern (e.g., scores, wrinkles, folds, and the like) or even have a roughened surface. The spacer material can also have printed thereon a surface pattern (e.g., a printed ceramic paste) so as to reduce the contact area and/or friction between the spacer material and surfaces that are adjacent to the spacer material.

The disclosed articles can comprise a third wall disposed such that the second wall is between the first and third walls. The third wall can be formed of the same material as the first and/or second walls, although this is not a requirement. An article can comprise a second insulating space disposed between the second and third walls. The second insulating space can be configured as the first insulating space, which is described elsewhere herein.

One or more portions of reflective material can be disposed within the second insulating space. Suitable reflective materials are described elsewhere herein. As one example, an article can include inner (first), middle (second), and outer (third) walls, with a first sealed space between the inner (first) and middle walls and a second sealed space between the middle and outer (second) walls. One or more portions of reflective material can be disposed within the first sealed space, and one or more potions of spacer material can be disposed within the first sealed space. Likewise, one or more portions of reflective material can be disposed within the second sealed space, and one or more potions of spacer material can be disposed within the second sealed space.

Other articles disclosed herein comprise first and second walls defining a sealed vacuum space disposed therebetween; and at least one portion of reflective material disposed within the sealed vacuum space. One or both of the first and second walls can comprise stainless steel.

Suitable walls and wall configurations are described elsewhere herein. Walls can be flat, curved, tubular, polygonal, or otherwise shaped.

A sheathing material can be disposed adjacent to the first wall, disposed adjacent to the second wall, or both. An article can comprise a third wall disposed such that the second wall is between the first and third walls. A second insulating space can be disposed between the second and third walls. One or more portions of reflective material can be disposed within the second insulating space.

The presently disclosed articles are suitable for use in electronic devices (or components thereof), energy storage devices, chemical storage devices, combustion devices, and the like.

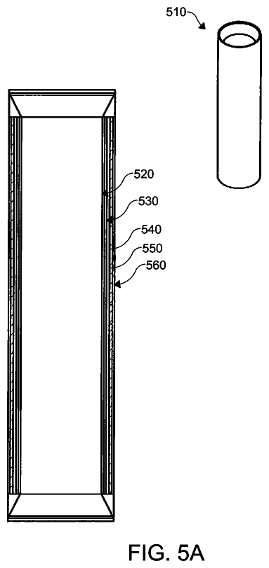

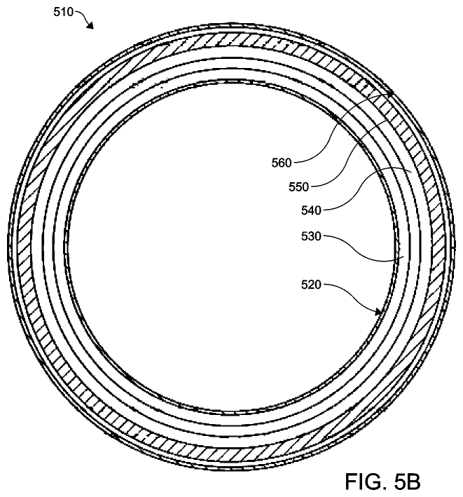

Exemplary articles are provided in FIG. 5A and FIG. 5B. As shown in the upper right of FIG. 5A, an article according to the present disclosure can be tubular in configuration. Articles need not be tubular, however, as they can also be curved, cubic, cup-shaped, or otherwise shaped.

The cutaway view on the left side of FIG. 5A illustrates an article 510 having inner wall (first) 520 and outer (second) wall 560. A vacuum space 540 is formed between these walls, and an amount (e.g., a spiral sheet) of reflective material 530 is disposed within that space. (As described elsewhere herein, the reflective material can comprise a reflective fabric, a metallic sheeting material, or both.) A sheath material (e.g., a braided ceramic material) 550 can also be present in the space, though this is optional. The sheath material can be present in the form of a sheet, spiral or even a ribbon. Sheath material can be disposed adjacent to the first, second, or both walls of the article.

FIG. 5B provides a cross-sectional view of the article of FIG. 5A. As shown in FIG. 5B, the exemplary article 510 has outer (second) wall 560 and inner (first) wall 520. The sheath material 550 is shown as inside the vacuum space 540 and adjacent to the outer (second) wall 560, though this is not a requirement. The reflective material 540 is disposed between the sheath material 550 and the inner (first) wall 520 of the article 510. (As described elsewhere herein, the reflective material can comprise a reflective fabric, a metallic sheeting material, or both.)

It should be understood that although some embodiments comprise cylindrical form factors, the present disclosure contemplates other form factors. For example, walls can be arranged in a parallel fashion.

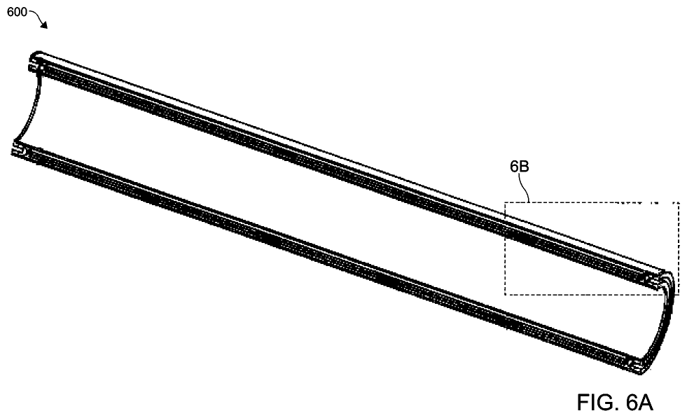

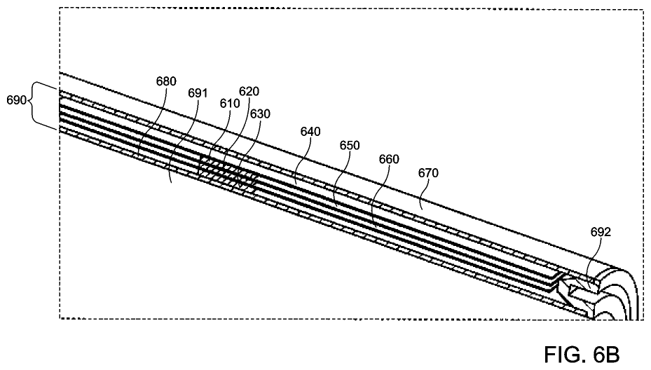

A further exemplary embodiment is shown in FIG. 6A, which FIG. shows a cutaway view of an article 600 according to the present disclosure. At the right-hand side of FIG. 6A is a box, which box outlines the magnified view shown in FIG. 6B.

FIG. 6B presents a magnified view of the boxed area of FIG. 6A. As shown, an article can include an outer (second) wall 670 and an inner (first) wall 680, between which outer (second) wall and inner (first) wall is defined insulating space 690, which insulating space can be evacuated as described elsewhere herein. The inner (first) wall can define within a volume 691. In the exemplary embodiment of FIG. 6B, the inner (first) wall 680 and the outer (second) wall 670 are tubular and concentric with one another, thereby forming a tube having a volume (lumen) within. The article can include end fitting 692, which end fitting serves to seal between inner (first) wall 680 and outer (second) wall 670 so as to define vacuum space 690.

Within vacuum space 690 there can be disposed a first amount 640 of reflective material. (As described elsewhere herein, the reflective material can comprise a reflective fabric, a metallic sheeting material, or both.) One portion of the reflective material can, optionally, be secured to another portion of the reflective material so as to form a seal or joint, e.g., to form a tube or cylinder from a sheet or ribbon of reflective material. Within vacuum space 690 there can also be disposed a second amount 650 and a third amount 660 of reflective material.

A spacer material can, optionally, be disposed between the reflective material and a wall of the article or even between two amounts of reflective material. In exemplary FIG. 6B, first spacer 610 is disposed between first amount 640 of reflective material and second amount 650 of reflective material. Second spacer 620 can be disposed between second amount 650 of reflective material and third amount 660 of reflective material. Third spacer 630 can be disposed between inner (first) wall 680 of the article and third amount 660 of reflective material.

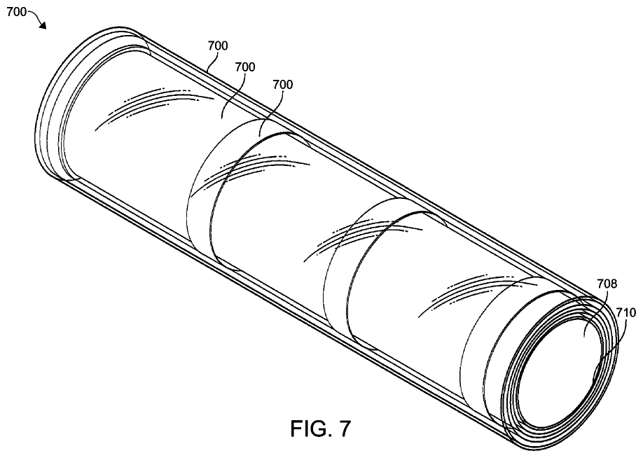

FIG. 7 provides a cutaway view of a further article 700 according to the present disclosure. As shown in FIG. 7, article 700 can include inner (first) wall 710 and outer (second) wall 702, which inner (first) wall and outer (second) wall can define a space (not labeled) (suitably an evacuated space) therebetween. Inner (first) wall 710 can define within a volume 708.

Within the space defined between inner (first) wall 710 and outer (second) wall 702 can be an amount of reflective material 704. A spacer material 706 can, optionally, be disposed in contact with the reflective material 704. (As described elsewhere herein, the reflective material can comprise a reflective fabric, a metallic sheeting material, or both.)

It should be understood that the reflective material need not be present in a cylindrical form that encircles the inner wall; reflective material can be present as a spiral (similar to the stripes on a barber's pole). Reflective material can also be present as a partial enclosure of the inner wall of the invention, e.g., as a cylinder that arcs about less than 360 degrees of the circumference of the inner wall.

As shown in FIG. 7, spacer material 706 can be present as a ring, encircling reflective material 704. (As described elsewhere herein, the reflective material can comprise a reflective fabric, a metallic sheeting material, or both.) It should be understood that the spacer material need not be present as an encircling ring; spacer material can be present as a spiral (similar to the stripes on a barber's pole). Spacer material can also be present as strips (e.g., rings) that are aligned parallel to the major axis of the article, perpendicular to the major axis of the article, or even at an angle (acute, obtuse, or 45 degrees) relative to the major axis of the article. It should also be understood that spacer and sheathing materials are optional, and need not be present.

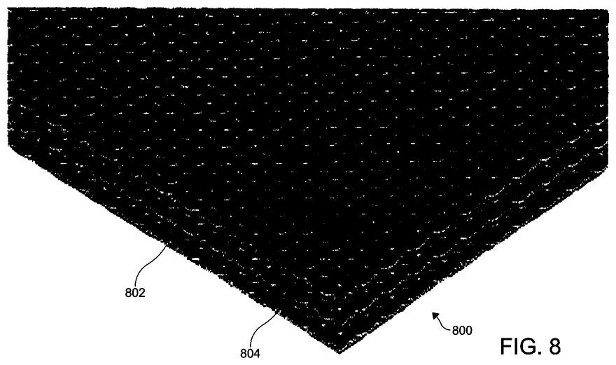

FIG. 8 provides a depiction of an exemplary reflective material according to the present disclosure. As shown, a reflective insert 800 can comprise an amount of reflective fabric 804 and also an amount of a metallic sheeting material 802. Reflective fabric 804 and metallic sheeting material 802 can be arranged in a sandwich-like manner, with alternating layers of each. In one embodiment, an amount of metallic reflective material can be sandwiched between two layers of reflective fabric. In another embodiment, an amount of metallic sheeting material can be sandwiched between two layers of reflective fabric. It should be understood that a reflective insert can include only reflective fabric or only metallic sheeting material, although it can be useful to include both reflective fabric and metallic sheeting material in such an insert.

The metallic sheeting material and reflective material can be stitched together (e.g., at an edge of one or both) or otherwise adhered to one another. This is not a requirement, as the metallic sheeting material and reflective material can be separate from one another, i.e., not attached to one another.

The present disclosure provides other, alternative vacuum-insulated vessels, such vessels comprising: a first wall and a second wall defining a first insulating space of reduced pressure disposed between the first and second walls. The second wall suitably encloses the first wall, and the first wall encloses and defines a storage volume.

A vessel can also comprise a first conduit disposed so as to place the storage volume into fluid communication with the environment exterior to the vessel. Vessels can also include a first vent communicating with the first insulating space to provide an exit pathway for gas molecules from the first insulating space, the first vent being sealable for maintaining a first vacuum within the first insulating space following evacuation of gas molecules through the first vent; a first seal sealing the first insulating space at the first vent; and at least one portion of reflective material (which, as described elsewhere herein, can include reflective fabric, metallic sheeting, or both) disposed within the first insulating space.

The insulating space can be evacuated, e.g., a vacuum space. Some exemplary vacuum-insulated structures (and related techniques for forming and using such structures) are described elsewhere herein.

It should be understood that a vacuum (i.e., any vacuum within the disclosed devices and methods) can be effected by the methods in the aforementioned applications or by any other method known in the art.

An insulating space can have a pressure of, e.g., from less than about 760 Torr to about 1×10⁻⁹ Torr. Pressures of about 10⁻¹, 10⁻², 10⁻³, 10⁻⁴, 10⁻⁵, 10⁻⁶, 10⁻⁷, 10⁻⁸, and even about 10⁻⁹ Torr are all considered suitable. An insulating space can be oxide-free or substantially oxide-free.

Reflective material within an insulating space can be oxide-free or substantially oxide-free. The reflective material can reflect UV, IR, or even visible illumination. The reflective material can be present as a strip, sheet, or in other form.

An article according to the present disclosure can be formed from materials selected such that the article maintains its shape and integrity at up to about 2500 deg. F., up to about 2400 deg. F., up to about 2300 deg. F., up to about 2200 deg. F., up to about 2100 deg. F., or even up to about 2000 deg. F.

In a vessel according to the present disclosure, at least one of the first and second walls comprises a curvilinear region. Hemispherical and conical walls are all considered suitable. At least one of the first or second walls can also comprise a linear region.

A vessel can have a tubular or barrel-shaped central portion that features two curved (e.g., hemispherical) portions at either end of the tubular region. A vessel can be spherical, ovoid, cylindrical, or even polygonal (e.g., a six-sided column) in shape.

A vessel can be oblong in shape, with flattened top and bottom portions and curved sidewall portions. A vessel can have flattened portions, curved portions, or any combination of these.

A vessel can also include one or more fittings (e.g., brackets, screw-downs, and the like) that allow the vessel to engage with a device, vehicle, or other modality that requires access to the fluid disposed within the vessel.

The storage volume of the disclosed vessels can be sealed against the environment exterior to the vessel, so as to contain the fluid for use at a later time. A fluid (e.g., hydrogen, helium, nitrogen, oxygen) can be stored within the storage volume. The contents of the storage volume can be pressurized, e.g., pressurized so as to maintain the contents in liquid form. The vessel can accordingly act so as to thermally insulate the contents from the environment exterior to the vessel.

In some embodiments, the first conduit can be insulated, e.g., be vacuum-insulated. (Alternatively, a first conduit can comprise an insulation-filled space between the conduit's inner (first) and outer (second) walls.) The first conduit can comprise a first conduit wall and a second conduit wall, the first and second conduit walls defining therebetween an insulating conduit space of reduced pressure.

The first conduit can also comprise a first vent communicating with the insulating conduit space so as to provide an exit pathway for gas molecules from the insulating conduit space, the first vent being sealable for maintaining a first vacuum within the insulating conduit space following evacuation of gas molecules through the first vent, the first conduit further comprising a first seal sealing the first insulating space at the first vent.

A vessel can also include a baffle wall. The baffle wall can be disposed within the first wall of the vessel, the baffle wall at least partially enclosing the storage volume, and the baffle wall and the first wall of the vessel defining a spillover volume therebetween, the spillover volume being capable of fluid communication with the storage volume.

A vessel can further include a stop flow device configured to interrupt fluid communication between the storage volume and the spillover volume. A valve, stopcock, or other device can be used. A user can recover fluid (e.g., in vapor form) from the spillover volume. The spillover volume can be configured to receive fluid (e.g., fluid that has boiled-off) from the storage volume.

Vessels can also include a spillover conduit, the spillover conduit comprising a first spillover conduit wall and a second spillover conduit wall, the first and second spillover conduit walls defining therebetween an insulating spillover conduit space of reduced pressure.

A spillover conduit can also comprise a first vent communicating with the insulating spillover conduit space so as to provide an exit pathway for gas molecules from the insulating spillover conduit space, the first vent being sealable for maintaining a first vacuum within the insulating spillover conduit space following evacuation of gas molecules through the first vent, the first spillover conduit further comprising a first seal sealing the first insulating space at the first vent.

A vessel can include a jacket material that encloses the vessel. The jacket material can contact the second wall of the vessel. The jacket material can comprise a woven composite, a braided composite, a non-woven composite, or any combination thereof.

The jacket material can be configured to improve the ability of the vessel to withstand an internal or even an external pressure or external impact. The jacket material can be a composite, e.g., a composite formed from one or more fiber types and one or more polymer matrices. The jacket material can also comprise one or more materials that add insulation properties to the vessel. This insulation can be formed to limit the conduction of the vessel. The jacket material can also include a material, such as a copper lining, that limits radiation (e.g., thermal radiation) into or out of the vessel. A jacket material can enclose a portion of or even enclose the entire vessel. In some embodiments, the jacket material encloses at least 50% of the surface area of the vessel.

A vessel can also include a fluid disposed within the storage volume. Hydrogen, helium, nitrogen, and other gases are all considered suitable such fluids. The fluid can be in liquid form or in vapor form.

Vessels can also include a heat source in thermal communication with the storage volume. The heat source can be disposed within the vessel, but can also be disposed exterior to the vessel. The heat source can be battery-powered, solar-powered, chemically-powered, or even powered by a reaction of the fluid (e.g., hydrogen) disposed within the vessel.

Also provided are methods. The methods suitably comprise disposing an amount of a fluid into the storage volume of a vessel according to the present disclosure. The fluid can comprise, e.g., hydrogen. The disclosed methods can also include sealing the fluid within the vessel.

Other disclosed methods include removing an amount of a fluid from the storage volume of a vessel according to the present disclosure. The recovery can be assisted by a vacuum; recovery can also be effected by utilizing the pressure of the pressurized fluid within the vessel. The user can also convert some or all of the fluid into electrical, thermal, or even mechanical energy.

Further disclosed methods include removing an amount of a fluid from the spillover volume of a vessel according to the present disclosure. The fluid can comprise hydrogen. The user can also convert some or all of the fluid into electrical, thermal, or even mechanical energy.

The disclosed vessels can be used as fuel tanks for vehicles, e.g., aircraft (manned and unmanned), marine vehicles, automobiles, and the like. The vessels can also be used as fuel tanks for dwellings (temporary and permanent), commercial operations, medical facilities, and the like.

Figures

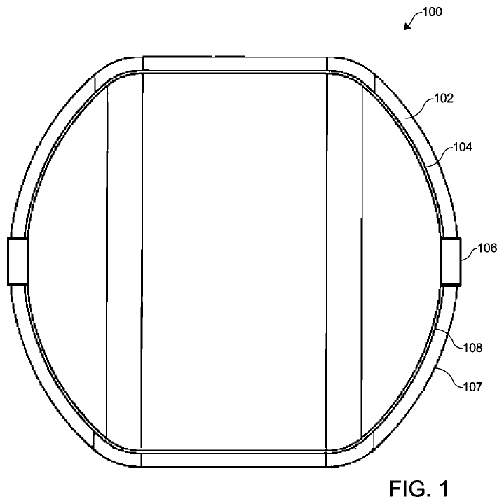

FIG. 1 depicts a cutaway view of an exemplary insulated vessel 100 according to the present disclosure. As shown, the vessel 100 can comprise a vacuum region 102, which vacuum region can be formed between the first (inner) wall 104 and second (outer) wall 107 of the vessel. Inner (first) wall 104 can be considered to define a pressure vessel and a storage volume therein.

The vessel 100 can also include a feedthrough 106; the feedthrough 106 can place the storage volume into fluid communication with the environment exterior to the vessel, e.g., in a fuel tank embodiment wherein a fuel material (e.g., a gas or other fluid) is stored within the storage volume defined within inner (first) wall 108. The feedthrough 106 can comprise a valve, a conduit (including insulated conduits, as described elsewhere herein), or other modality (e.g., a stopper) that modulates fluid movement.

As shown in FIG. 1, vessel 100 can also comprise a reflective material (e.g., a reflective fabric, a metallic sheeting material, or both) 108, which can be disposed within the vacuum region. Suitable reflective materials are described elsewhere herein; also as described elsewhere herein, an article can include one or more amounts of spacer material. As one example, a sealed insulating space of an article according to the present disclosure can have a spacer material disposed therein. Ceramic materials are suitable spacer materials.

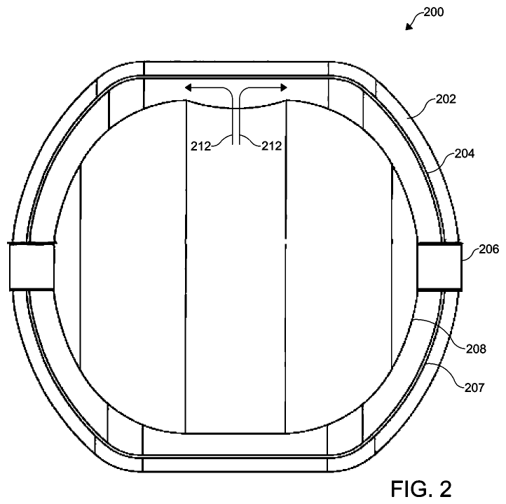

FIG. 2 provides a cutaway view of an alternative vessel 200 according to the instant disclosure. As shown, vessel 200 can include insulating vacuum region 202, which is formed between the first (inner) wall 204 and the second (outer) wall of the vessel (not labeled). Vessel 200 can also include a feedthrough 206; feedthrough 206 can place the storage volume into fluid communication with the environment exterior to the vessel. Feedthrough 206 can comprise a valve, a conduit (including insulated conduits, as described elsewhere herein), or other modality that modulates fluid movement. Vessel 200 can also include a reflective material 210 (e.g., a reflective fabric, a metallic sheeting material, or both), disposed within the vacuum region.

A vessel 200 can further include a shield (which can be vapor-cooled) or baffle 208 disposed within the device. The baffle can enclose the storage volume, which storage volume can contain a fluid (e.g., hydrogen). The vessel 200 can further define a boil-off flow path 212, which allows vapor to exit from the storage volume within the vessel. This can be used, e.g., when a vessel has disposed within a material that evolves vapor under storage conditions. A vessel can also include a jacket or other shielding disposed on the exterior of the vessel so as to protect the vessel from environmental forces.

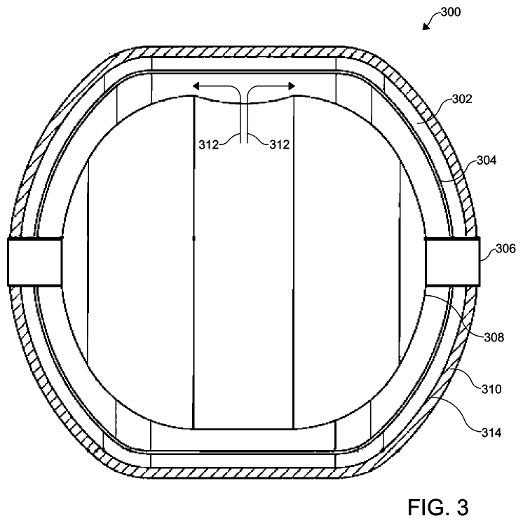

FIG. 3 provides another alternative vessel 300. As shown, the vessel 200 can include insulating vacuum region 302, which is formed between the first (inner) wall 304 and the second (outer) wall of the vessel 314. Vessel 300 can also include a feedthrough 306; the feedthrough 306 can place the storage volume into fluid communication with the environment exterior to the vessel. The feedthrough comprise a valve, a conduit (including insulated conduits, as described elsewhere herein), or other modality that modulates fluid movement. Vessel 300 can also include a reflective material (not shown; the reflective material can be a reflective fabric, a metallic sheeting material, or both) disposed within vacuum region 302.

A vessel 300 can further include a vapor cooled shield or baffle 308 disposed within the device. The baffle can enclose the storage volume, which storage volume can contain a fluid (e.g., hydrogen). The vessel 300 can further define a boil-off flow path 312, which allows vapor to exit from the storage volume within the vessel. Vessel 300 can further comprise a jacket material 310.

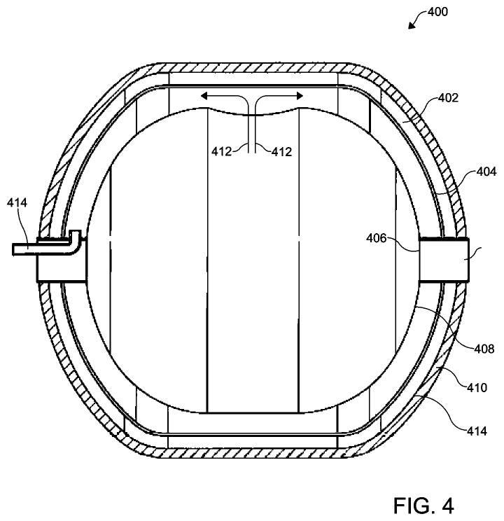

FIG. 4 provides another alternative vessel 400. As shown, the vessel 400 can include insulating vacuum region 402, which is formed between the first (inner) wall 404 and the second (outer) wall 414 of the vessel. Vessel 400 can also include a feedthrough 406; the feedthrough 406 can place the storage volume into fluid communication with the environment exterior to the vessel. The feedthrough comprise a valve, a conduit (including insulated conduits, as described elsewhere herein), or other modality that modulates fluid movement.

Vessel 400 can also include a reflective material (not shown; the reflective material can be a reflective fabric, a metallic sheeting material, or both) disposed within the vacuum region.

A vessel 400 can further include a vapor cooled shield or baffle 408 disposed within the device. The baffle can enclose the storage volume, which storage volume can contain a fluid (e.g., hydrogen). The vessel 400 can further define a boil-off flow path 412 (which can be termed a spillover path or volume, in some embodiments), which allows vapor to exit from the storage volume within the vessel.

Vessel 400 can further comprise a jacket material 410. Vessel 400 can further comprise a spillover conduit 414, which permits a user to recover vapor or other fluid in the spillover region defined between the baffle 408 and wall 404.

Exemplary Insulating Article

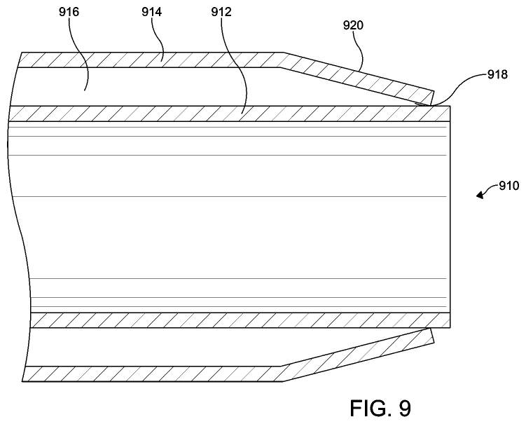

Referring to the drawings, where like numerals identify like elements, there is shown in FIG. 9 an end portion of a structure 910 according to the invention having gas molecule guiding geometry. Structure 910 appears in FIG. 9 at a scale that was chosen for clearly showing the gas molecule guiding geometry of the invention. The invention, however, is not limited to the scale shown and has application to devices of any scale from miniaturized devices to devices having insulating spaces of very large dimensions. Structure 10 includes inner and outer tubes 912, 914, respectively, sized and arranged to define an annular space 916 therebetween. The tubes 912, 14 engage each other at one end to form a vent 918 communicating with the vacuum space 916 and with an exterior. The vent 918 provides an evacuation path for egress of gas molecules from space 16 when a vacuum is applied to the exterior, such as when structure 910 is placed in a vacuum chamber, for example.

The vent 918 is sealable in order to maintain a vacuum within the insulating space following removal of gas molecules in a vacuum-sealing process. In its presently preferred form, the space 916 of structure 910 is sealed by brazing tubes 912, 914 together. The use of brazing to seal the evacuation vent of a vacuum-sealed structure is generally known in the art. To seal the vent 918, a brazing material (not shown) is positioned between the tubes 912, 914 adjacent their ends in such a manner that, prior to the brazing process, the evacuation path defined by the vent 918 is not blocked by the material. During the evacuation process, however, sufficient heat is applied to the structure 910 to melt the brazing material such that it flows by capillary action into the evacuation path defined by vent 918. The flowing brazing material seals the vent 918 and blocks the evacuation path. A brazing process for sealing the vent 918, however, is not a requirement of the invention. Alternative methods of sealing the vent 918 could be used, such as a metallurgical or chemical processes.

The geometry of the structure 10 effects gas molecule motion in the insulating space 916 in the following manner. A major assumption of Maxwell's gas law regarding molecular kinetic behavior is that, at higher concentrations of gas molecules, the number of interactions occurring between gas molecules will be large in comparison to the number of interactions that the gas molecules have with a container for the gas molecules. Under these conditions, the motion of the gas molecules is random and, therefore, is not affected by the particular shape of the container. When the concentration of the gas molecules becomes low, however, as occurs during evacuation of an insulating space for example, molecule-to-molecule interactions no longer dominate and the above assumption of random molecule motion is no longer valid. As relevant to the invention, the geometry of the vacuum space becomes a first order system effect rather than a second order system effect when gas molecule concentration is reduced during evacuation because of the relative increase in gas molecule-to-container interactions.

The geometry of the insulating space 916 guides gas molecules within the space 916 toward the vent 918. As shown in FIG. 9, the width of the annular space 916 is not uniform throughout the length of structure 910. Instead, the outer tube 914 includes an angled portion 920 such that the outer tube converges toward the inner tube 12 adjacent an end of the tubes. As a result the radial distance separating the tubes 912, 914 varies adjacent the vent 18 such that it is at a minimum adjacent the location at which the vent 18 communicates with the space 16. As will be described in greater detail, the interaction between the gas molecules and the variable-distance portion of the tubes 912, 914 during conditions of low molecule concentration serves to direct the gas molecules toward the vent 918.

The molecule guiding geometry of space 916 provides for a deeper vacuum to be sealed within the space 916 than that which is imposed on the exterior of the structure 910 to evacuate the space. This somewhat counterintuitive result of deeper vacuum within the space 916 is achieved because the geometry of the present invention significantly increases the probability that a gas molecule will leave the space rather than enter. In effect, the geometry of the insulating space 16 functions like a check valve to facilitate free passage of gas molecules in one direction (via the exit pathway defined by vent 18) while blocking passage in the opposite direction.

As shown in FIG. 9, the angled portion 920 of tube 914 of structure 10 extends to the end of tube 914 as tube 914 converges toward tube 912. This is not a requirement, however, as a tube can include an angled portion that does not extend all the way to the immediate end of the tube. As one example, a tube can have a first region having a first inner diameter, which first region transitions to an angled region having a variable diameter, which angled region transitions to a second region having a second inner diameter; the first and second regions can even be parallel to one another. (The second inner diameter can be smaller than the first inner diameter.)

A benefit associated with the deeper vacuums provided by the geometry of insulating space 916 is that it is achievable without the need for a getter material within the evacuated space 916. The ability to develop such deep vacuums without a getter material provides for deeper vacuums in devices of miniature scale and devices having insulating spaces of narrow width where space constraints would limit the use of a getter material.

Although not required, a getter material could be used in an evacuated space having gas molecule guiding structure according to the invention. Other vacuum enhancing features could also be included, such as low-emissivity coatings on the surfaces that define the vacuum space. The reflective surfaces of such coatings, generally known in the art, tend to reflect heat-transferring rays of radiant energy. Limiting passage of the radiant energy through the coated surface enhances the insulating effect of the vacuum space.

The construction of structures having gas molecule guiding geometry according to the present invention is not limited to any particular category of ceramics.

Suitable ceramic materials include, e.g., alumina (Al₂O₃, mullite, zirconia (ZrO₂) (including yttria-stabilized, yttria partially-stabilized, and magnesia partially-stabilized zirconia), silicon carbide, silicon nitride, and other glass-ceramic combinations.

The ceramic material can include a second material such as mica that causes the heat path around the second material to be longer. The second material can be configured in such a manner to be aligned with the lumen of the invention, perpendicular to the lumen of the invention, or any angle between. The second material can also be configured in a random manner within the ceramic. The second material can be, e.g., an opacifier that has a significantly different refractive index than the base ceramic. The opacifier assists in turning the radiation into conduction. Since certain ceramics are efficient at limited conduction.

Referring again to the structure 910 shown in FIG. 9, the convergence of the outer tube 914 toward the inner tube 912 in the variable distance portion of the space 916 provides guidance of molecules in the following manner. When the gas molecule concentration becomes sufficiently low during evacuation of space 916 such that structure geometry becomes a first order effect, the converging walls of the variable distance portion of space 916 will channel gas molecules in the space 916 toward the vent 918. The geometry of the converging wall portion of the vacuum space 916 functions like a check valve or diode because the probability that a gas molecule will leave the space 916, rather than enter, is greatly increased.

The effect that the molecule guiding geometry of structure 910 has on the relative probabilities of molecule egress versus entry can be understood by analogizing the converging-wall portion of the vacuum space 916 to a funnel that is confronting a flow of particles. Depending on the orientation of the funnel with respect to the particle flow, the number of particles passing through the funnel would vary greatly. It is clear that a greater number of particles will pass through the funnel when the funnel is oriented such that the particle flow first contacts the converging surfaces of the funnel inlet rather than the funnel outlet.

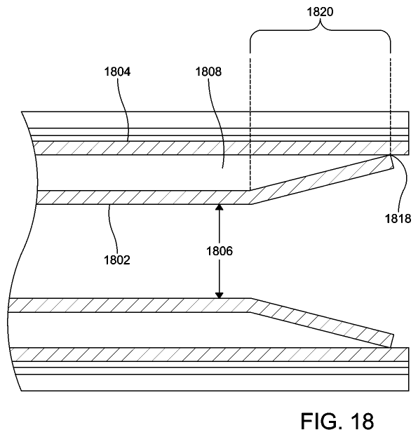

FIG. 18 provides a view of an alternative embodiment. As shown in that figure, an insulated article can include inner tube 1802 and outer tube 1804, which tubes define insulating space 1808 therebetween. Inner tube 1802 also defines a lumen within, which lumen can have a cross-section (e.g., diameter) 1806. Insulating space 1808 can be sealed by sealable vent 1818. As shown in FIG. 18, inner tube 1802 can include a portion 1820 that flares outward toward outer tube 1804, so as to converge towards outer tube 1804.

The convergence of the outer tube 1804 toward the inner tube 1802 in the variable distance portion of the space 1808 provides guidance of molecules in the following manner. When the gas molecule concentration becomes sufficiently low during evacuation of space 1808 such that structure geometry becomes a first order effect, the converging walls of the variable distance portion of space 1808 will channel gas molecules in the space 1808 toward the vent 1818. The geometry of the converging wall portion of the vacuum space 1808 functions like a check valve or diode because the probability that a gas molecule will leave the space 1808, rather than enter, is greatly increased.

Various examples of devices incorporating a converging wall exit geometry for an insulating space to guide gas particles from the space like a funnel are shown in FIGS. 2-7. However, it should be understood that the gas guiding geometry of the invention is not limited to a converging-wall funneling construction and can, instead, utilize other forms of gas molecule guiding geometries. For example, the Dewar shown in FIG. 8 and described in greater detail below, incorporates an alternate form of variable distance space geometry according to the invention.

Some exemplary vacuum-insulated structures (and related techniques for forming and using such structures) can be found in United States published patent applications 2017/0253416; 2017/0225276; 2017/0120362; 2017/0062774; 2017/0043938; 2016/0084425; 2015/0260332; 2015/0110548; 2014/0090737; 2012/0090817; 2011/0264084; 2008/0121642; and 2005/0211711, all by A. Reid, and all incorporated herein by reference in their entireties for any and all purposes.

Insulated Probes

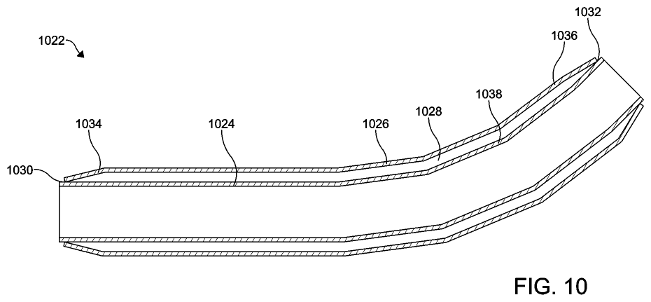

Referring to FIG. 10, there is shown a structure 1022 incorporating gas molecule guiding geometry according to the invention. Structure 1022 includes inner and outer tubes 1024, 1026 defining an annular vacuum space 1028 therebetween. Structure 1022 includes vents 1030, 1032 and angled portions 1034, 1036 of outer tube 26 at opposite ends that are similar in construction to vent 818 and angled portion 920 of structure 90 of FIG. 9.

The structure 1022 can be useful, for example, in an insulated surgical probe. In such an application, it can be desirable that the structure 1022 be bent as shown to facilitate access of an end of the probe to a particular target site. In some embodiments, the concentrically arranged tubes 1024, 26 of structure 1022 have been bent such that the resulting angle between the central axes of the opposite ends of the structure is approximately 45 degrees.

To enhance the insulating properties of the sealed vacuum layer, an optical coating 1028 having low-emissivity properties can be applied to the outer surface of the inner tube 1024. The reflective surface of the optical coating limits passage of heat-transferring radiation through the coated surface. The optical coating can comprise copper, a material having a desirably low emissivity when polished. Copper, however, is subject to rapid oxidation, which would detrimentally increase its emissivity. Highly polished copper, for example, can have an emissivity as low as approximately 0.02 while heavily oxidized copper can have an emissivity as high as approximately 0.78.

As an example, a copper coating can be added to the inner surface of the outer wall 1034, the outer surface of the outer wall 1034, and/or the inner surface of the inner wall 1024 defined according to the present disclosure.

Copper layers can be used in conjunction with each other. As one example, inner walls exposed to the vacuum space can be coated with a reflective material.

To facilitate application, cleaning, and protection of the oxidizing coating, the optical coating is preferably applied to the inner tube 1024 using a radiatively-coupled vacuum furnace prior to the evacuation and sealing process. When applied in the elevated-temperature, low-pressure environment of such a furnace, any oxide layer that is present will be dissipated, leaving a highly cleaned, heat polished, low-emissivity surface, which will be protected against subsequent oxidation within the vacuum space 1028 when the evacuation path is sealed.

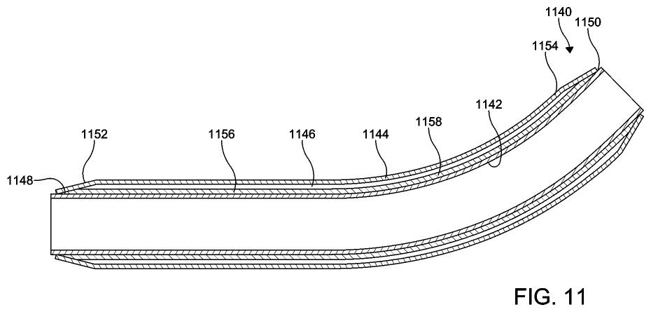

Referring to FIG. 11, there is shown another structure 1140 incorporating having gas molecule guiding geometry according to the invention. Similar to structure 90 of FIG. 9, structure 1140 includes inner and outer tubes 1142, 1144 defining an annular vacuum space 1146 therebetween. Structure 1140 includes vents 1148, 1150 and angled portions 1152, 1154 of outer tube 1144 at opposite ends similar in construction to vent 918 and angled portion 920 of structure 90 of FIG. 9. Preferably, the concentrically arranged tubes 1142, 1144 of structure 1140 have been bent such that the resulting angle between the central axes of the opposite ends of the structure is approximately 45 degrees. The structure 1140, similar to structure 1022 of FIG. 10, includes an optical coating 1156 applied to the outer surface of inner tube 1142.

When concentrically arranged tubes, such as those forming the vacuum spaces of the probes structures of FIGS. 10 and 11, are subjected to bending loads, contact can occur between the inner and outer tubes while the loading is imposed. The tendency of concentric tubes bent in this fashion to separate from one another, or to “springback,” following removal of the bending loads can be sufficient to ensure that the tubes separate from each other. Any contact that does remain, however, could provide a detrimental “thermal shorting” between the inner and outer tubes, thereby defeating the intended insulating function for the vacuum space. To provide for protection against such thermal shorting, structure 1140 of FIG. 11 includes a layer 1158 of a spacer material, which is preferably formed by winding yarn or braid comprising micro-fibers of ceramic or other low conductivity material. The spacer layer 1158 provides a protective barrier that limits direct contact between the tubes.

Each of the structures of FIGS. 9-11 can be constructed as a stand-alone structure. Alternatively, the insulating structures of FIGS. 9-11 can form an integrated part of another device or system. Also, the insulating structures shown in FIGS. 9-11 can be sized and arranged to provide insulating tubing having diameters varying from sub-miniature dimensions to very large diameter and having varying length. In addition, as described previously, the gas molecule guiding geometry of the invention allows for the creation of deep vacuum without the need for getter material. Elimination of getter material in the space allows for vacuum insulation spaces having exceptionally small widths.

Joule-Thomson Devices

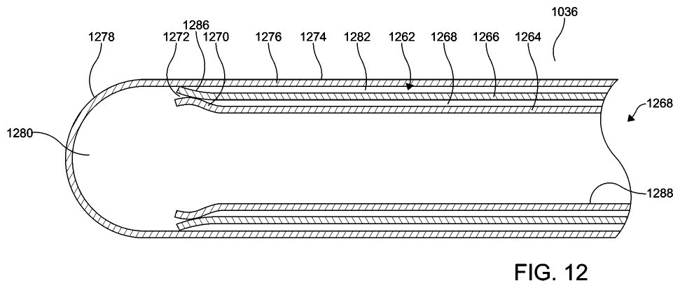

Referring to FIG. 12, there is shown a cooling device 60 incorporating gas molecule guiding geometry according to the present invention for insulating an outer region of the device 1260. The device 1260 is cooled utilizing the Joules-Thomson effect in which the temperature of a gas is lowered as it is expanded. First and second concentrically arranged tubes 1264 and 1266 define an annular gas inlet 1268 therebetween. Tube 1264 includes an angled portion 1270 that converges toward tube 1266. The converging-wall portions of the tubes 1264, 1266 form a flow-controlling restrictor or diffuser 1272 adjacent an end of tube 1264.

The cooling device 1260 includes an outer jacket 1274 having a cylindrical portion 1276 closed at an end by a substantially hemispherical portion 1278. The cylindrical portion 1276 of the outer jacket 1274 is concentrically arranged with tube 1266 to define an annular insulating space 1282 therebetween. Tube 1266 includes an angled portion 1284 that converges toward outer jacket 1274 adjacent an evacuation path 86. The variable distance portion of the insulating space 1282 differs from those of the structures shown in FIGS. 9-11 because it is the inner element, tube 1264, that converges toward the outer element, the cylindrical portion 1276. The functioning of the variable distance portion of insulating space 1282 to guide gas molecules, however, is identical to that described above for the insulating spaces of the structures of FIGS. 9-11.

The annular inlet 1268 directs gas having relatively high pressure and low velocity to the diffuser 1272 where it is expanded and cooled in the expansion chamber 80. As a result, the end of the cooling device 1260 is chilled. The expanded low-temperature/low-pressure is exhausted through the interior of the inner tube 1264. The return of the low-temperature gas via the inner tube 1264 in this manner quenches the inlet gas within the gas inlet 1268. The vacuum insulating space 1282, however, retards heat absorption by the quenched high-pressure side, thereby contributing to overall system efficiency. This reduction in heat absorption can be enhanced by applying a coating of emissive radiation shielding material on the outer surface of tube 1266. The invention both enhances heat transfer from the high-pressure/low-velocity region to the low-pressure/low-temperature region and also provides for size reductions not previously possible due to quench area requirements necessary for effectively cooling the high pressure gas flow.

The angled portion 1270 of tube 1264, which forms the diffuser 1272, can be adapted to flex in response to pressure applied by the inlet gas. In this manner, the size of the opening defined by the diffuser 1272 between tubes 1264 and 1266 can be varied in response to variation in the gas pressure within inlet 1268. An inner surface 1288 of tube 1264 provides an exhaust port (not seen) for removal of the relatively low-pressure gas from the expansion chamber 1280.

Referring to FIGS. 13, 14, and 15, there is shown a cryogenic cooler 1390 incorporating a Joules-Thomson cooling device 1392. The cooling device 1392 of the cryogenic cooler 1390, similar to the device of FIG. 12, includes tubes 1394 and 1396 defining a high pressure gas inlet 1398 therebetween and a low-pressure exhaust port 13100 within the interior of tube 1394. The gas supply for cooling device 1390 is delivered into cooler 1390 via inlet pipe 13102. An outer jacket 13104 forms an insulating space 13106 with tube 96 for insulating an outer portion of the cooling device. The outer jacket 13104 includes an angled portion 13108 that converges toward the tube 1396 adjacent an evacuation path 13109. The converging walls adjacent the evacuation path 13109 provides for evacuation and sealing of the vacuum space 13106 in the manner described previously.

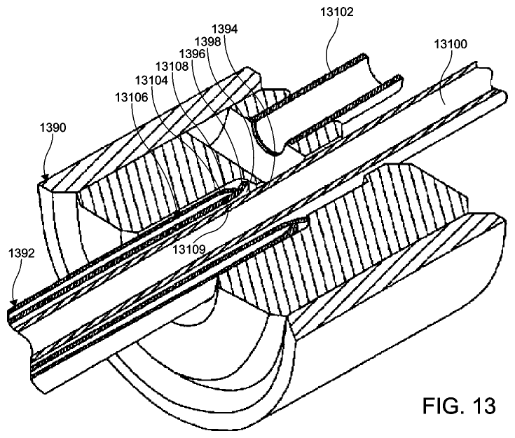

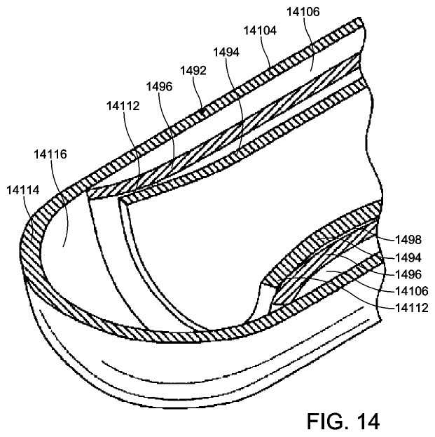

Referring to FIG. 14, the cooling device 1392 of the cryogenic cooler 90 includes a flow controlling diffuser 13112 defined between tubes 1394 and 1396. A substantially hemispherical end portion 13114 of outer jacket 13104 forms an expansion chamber 13116 in which expanding gas from the gas inlet 98 chills the end of the device 1392.

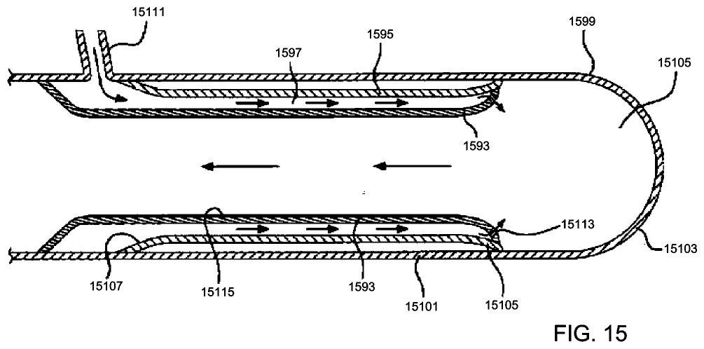

Referring to FIG. 15, there is shown a cooling device 1391 including concentrically arranged tubes 1393, 1395 defining an annular gas inlet 1397 therebetween. An outer jacket 1399 includes a substantially cylindrical portion 13101 enclosing tubes 1393, 1395 and a substantially semi-spherical end portion 13103 defining an expansion chamber 13105 adjacent an end of the tubes 1393, 1395. As shown, tube 1395 includes angled or curved end portions 13105, 13107 connected to an inner surface of the outer jacket 1399 to form an insulating space 13109 between the gas inlet 1397 and the outer jacket 1399. A supply tube 13111 is connected to the outer jacket adjacent end portion 13107 of tube 1395 for introducing gas into the inlet space 97 from a source of the gas.

The construction of the gas inlet 1397 of cooling device 1391 adjacent the expansion chamber 105 differs from that of the cooling devices shown in FIGS. 12-14, in which an annular escape path from the gas inlet was provided for delivering gas into the expansion chamber. Instead, tube 1393 of cooling device 1391 is secured to tube 1395 adjacent one end of the tubes 1393, 1395 to close the end of the gas inlet. Vent holes 13113 are provided in the tube 1393 adjacent the expansion chamber 105 for injection of gas into the expansion chamber 13105 from the gas inlet 1397. Preferably, the vent holes 13113 are spaced uniformly about the circumference of tube 1393. The construction of device 1391 simplifies fabrication while providing for a more exact flow of gas from the gas inlet 1397 into the expansion chamber 13105.

A coating 13115 of material having a relatively large thermal conductivity, preferably copper, is formed on at least a portion of the inner surface of tube 1393 to facilitate efficient transfer of thermal energy to the tube 1393.

Non-Annular Devices

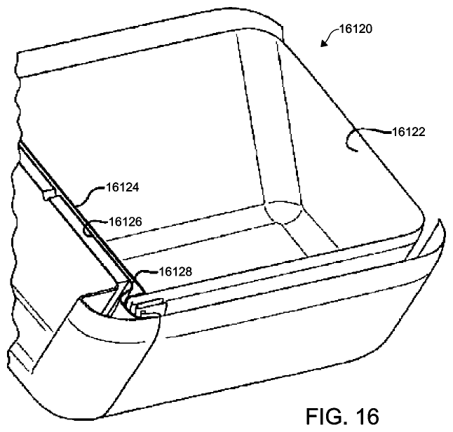

Each of the insulating structures of FIGS. 9-15 includes an insulating vacuum space that is annular. An annular vacuum space, however, is not a requirement of the invention, which has potential application in a wide variety of structural configurations. Referring to FIG. 16, for example, there is shown a vacuum insulated storage container 16120 having a substantially rectangular inner storage compartment 16122. The compartment 16122 includes substantially planar walls, such as wall 16124 that bounds a volume to be insulated. An insulating space 16128 is defined between wall 16124 and a second wall 16126, which is closely spaced from wall 16124. Closely spaced walls (not shown) would be included adjacent the remaining walls defining compartment 16122 to provide insulating spaces adjacent the container walls. The insulating spaces could be separately sealed or, alternatively, could be interconnected. In a similar fashion as the insulating structures of FIGS. 9-15, a converging wall portion of the insulating space 16128 (if continuous), or converging wall portions of insulating spaces (if separately sealed), are provided to guide gas molecules toward an exit vent. In the insulated storage container 16120, however, the converging wall portions of the insulated space 16128 is not annular.

The vacuum insulated storage container 16120 of FIG. 16 provides a container capable of indefinite regenerative/self-sustaining cooling/heating capacity with only ambient energy and convection as input energy. Thus, no moving parts are required. The storage container 16120 can include emissive radiation shielding within the vacuum insulating envelope to enhance the insulating capability of the vacuum structure in the manner described previously.

The storage container 16120 can also include an electrical potential storage system (battery/capacitor), and a Proportional Integrating Derivative (PID) temperature control system for driving a thermoelectric (TE) cooler or heater assembly. The TE generator section of the storage container would preferably reside in a shock and impact resistant outer sleeve containing the necessary convection ports and heat/light collecting coatings and or materials to maintain the necessary thermal gradients for the TE System. The TE cooler or heater and its control package would preferably be mounted in a removable subsection of a hinged cover for the storage container 16120. An endothermic chemical reaction device (e.g., a “chemical cooker”) could also be used with a high degree of success because its reaction rate would relate to temperature, and its effective life would be prolonged because heat flux across the insulation barrier would be exceptionally low.

Commercially available TE generator devices are capable of producing approximately 1 mW/in² with a device gradient of 20 deg. K approximately 6 mW/in² with a device gradient of 40 deg. K. Non-linear efficiency curves are common for these devices. This is highly desirable for high ambient temperature cooling applications for this type of system, but can pose problems for low temperature heating applications.

High end coolers have conversion efficiencies of approximately 60%. For example a 10 inch diameter container 10″ in height having 314 in² of surface area and a convective gradient of 20 deg. K would have a total dissipation capacity of approximately 30 mW. A system having the same mechanical design with a 40 .degree. K convective gradient would have a dissipation capacity of approximately 150 mW.

Examples of potential uses for the above-described insulated container 120 include storage and transportation of live serums, transportation of donor organs, storage and transportation of temperature products, and thermal isolation of temperature sensitive electronics.

Alternate Molecule Guiding Geometry

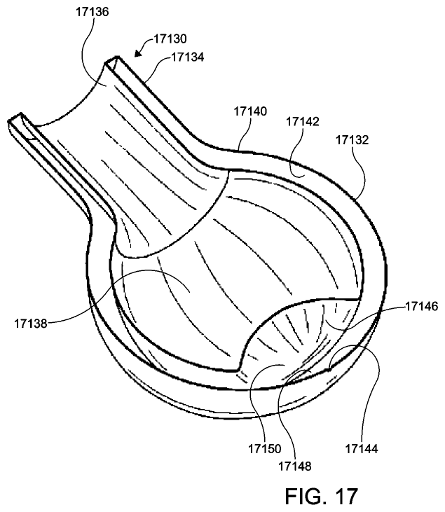

The present invention is not limited to the converging geometry incorporated in the insulated structure shown in FIGS. 9-16. Referring to FIG. 17, there is shown a Dewar 17130 incorporating an alternate form of gas molecule guiding geometry according to the invention. The Dewar 17130 includes a rounded base 17132 connected to a cylindrical neck 17134. The Dewar 17130 includes an inner wall 17136 defining an interior 17138 for the Dewar. An outer wall 17140 is spaced from the inner wall 17136 by a distance to define an insulating space 17142 therebetween that extends around the base 17132 and the neck 17134. A vent 17144, located in the outer wall 17140 of the base 17132, communicates with the insulating space 17142 to provide an exit pathway for gas molecules during evacuation of the space 17142.

A lower portion 17146 of the inner wall 17136 opposite vent 17144 is indented towards the interior 17138, and away from the vent 17144. The indented portion 17146 forms a corresponding portion 17148 of the insulating space 17142 in which the distance between the inner and outer walls 17136, 17140 is variable. The indented portion 17146 of inner wall 17136 presents a concave curved surface 17150 in the insulating space 17142 opposite the vent 17144. Preferably the indented portion 17146 of inner wall 17136 is curved such that, at any location of the indented portion a normal line to the concave curved surface 17150 will be directed substantially towards the vent 17144. In this fashion, the concave curved surface 150 of the inner wall 17136 is focused on vent 17144. The guiding of the gas molecules towards the vent 17144 that is provided by the focused surface 17150 is analogous to a reflector returning a focused beam of light from separate light rays directed at the reflector. In conditions of low gas molecule concentration, in which structure becomes a first order system effect, the guiding effect provided by the focused surface 17150 serves to direct the gas molecules in a targeted manner toward the vent 17144. The targeting of the vent 17144 by the focused surface 17150 of inner wall 17136 in this manner increases the probability that gas molecules will leave the insulating space 17142 instead of entering thereby providing deeper vacuum in the insulating space than vacuum applied to an exterior of the Dewar 17130.

Other Applications

The present invention has application for providing insulating layers in a wide range of thermal devices ranging from devices operating at cryogenic temperatures to high temperature devices. A non-limiting list of examples includes insulation for heat exchangers, flowing or static cryogenic materials, flowing or static warm materials, temperature-maintained materials, flowing gases, a heat generating device located on the inner surface of the lumen, a heat generating device located on the outer surface of the lumen, and/or temperature-controlled processes.

This invention allows direct cooling of specific micro-circuit components on a circuit. In the medical field, the present invention has uses in cryogenic or heat-therapy surgery, and insulates healthy tissue from the effects of extreme temperatures. An insulted container, such as container 120, will allow the safe transport over long distances and extended time of temperature critical therapies and organs.

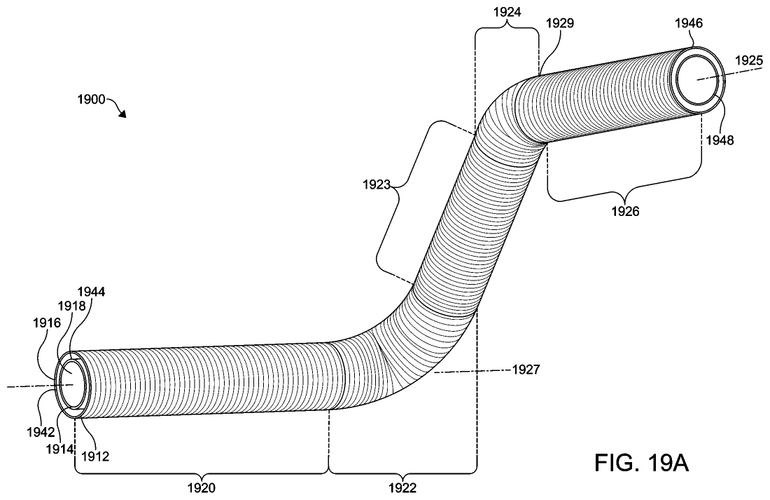

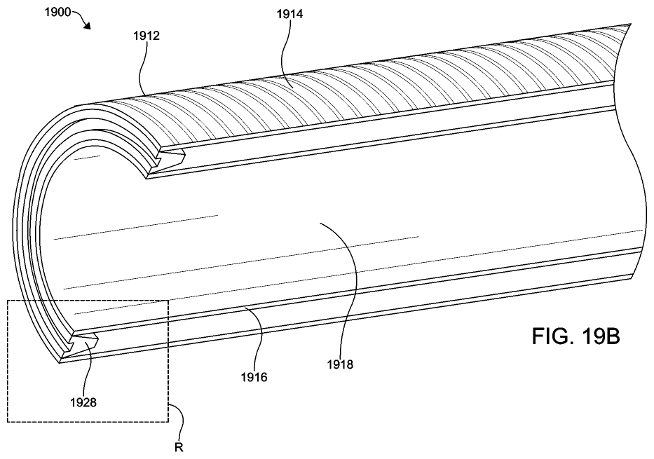

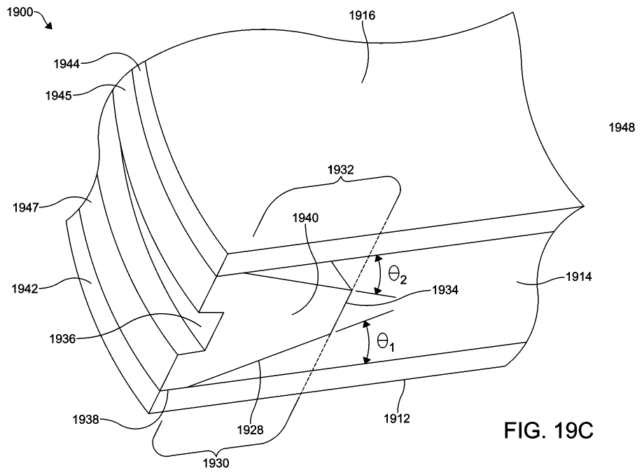

As shown in FIG. 19A, a conduit 1900 can comprise an inner tube 1916 and an outer wall 1912, between which is defined an insulating space 1914. The inner tube 1912 can enclose lumen 1918. As shown, article 1900 (which can be a conduit) can include straight portions, bent portions, or both. (One or both of inner tube 1916 and outer tube 1912 can be present as a tube.) Inner tube 1916 can have a first end 1944, and outer tube 1912 can have a first end 1942. The inner tube can suitably be formed of a single piece, and the outer tube can be suitably formed of a single piece.

In exemplary FIG. 19A, conduit/article 1900 can include a straight region 1920. A straight region can transition to a curved region, e.g., curved region 1922. A curved region can comprise a curvature of constant radius, but can also comprise a curvature of non-constant radius. A curved region can transition to another curved region or to a straight region; as shown in FIG. 19A, curved region 1922 can transition to a straight region 1923, which straight region can transition to another curved region, as shown by curved region 1924. As shown in FIG. 19A, the curved region 1924 can transition to a straight region, as shown by straight region 26. It should be understood that a conduit according to the present disclosure can comprise regions that bend in one or more planes. For example, as shown in FIG. 19A, curved region 1922 and curved region 1924 bend in different planes from one another.

A curved region can comprise a bend of, e.g., from about 1 to about 180 degrees (and all intermediate values), e.g., from 1 to 180 degrees, from about 5 to about 175 degrees, from about 10 to about 170 degrees, from about 15 to about 165 degrees, from about 20 to about 160 degrees, from about 30 to about 155 degrees, from about 45 to about 150 degrees, from about 50 to about 145 degrees, from about 55 to about 140 degrees, from about 60 to about 135 degrees, from about 65 to about 130 degrees, from about 70 to about 125 degrees, from about 75 to about 120 degrees, from about 80 to about 115 degrees, from about 85 to about 110 degrees, from about 90 to about 105 degrees, from about 95 to about 100 degrees.

A bend can be measured by the angle between the major axis of the lumen of the bend at the entrance of the bend and at the exit of the bend. By reference to FIG. 19A, straight region 1920 can have a (first) major axis 1927. Curved portion 1922—connected to straight portion 1920—comprises a curve, and curved portion 22 then connects to straight portion 1923, which defines a major axis 1929. Straight portion 1923 can in turn connect to curved portion 1924, which in turn connects to straight portion 26, which defines a (second) major axis 1925. (It should be understood that the foregoing description is illustrative only, as outer tube 1912 can be formed of a single piece that includes straight and/or bent regions.)

As shown in FIG. 19A, inner tube 1916 can define a second end 1948, and outer tube 1912 can define a second end 1946. A conduit can include a sealer (not shown) that seals the second ends of the inner and outer tubes, so as to seal the insulating space between the inner and outer tubes.

As shown in FIG. 19A, major axis 1929 can be at an angle relative to major axis 1927. Major axis 1925 can in turn be at an angle relative to major axis 1929. The ultimate result is that major axis 1925 can be at an angle relative to major axis 27 in one or more planes.

Insulating space 1914 can be evacuated. There can also be present (not shown) a spacing material in insulating space 1914, between inner tube1916 and outer tube 1912. A spacing material is suitably a heat-resistant material, in particular a material that experiences little to no outgassing when exposed to high temperatures. Suitable such materials include, e.g., ceramic materials (e.g., ceramic threads, including ceramic threads that are woven or braided into a structure). The spacing material can be present as a sleeve in configuration, and can be slid over inner tube 1916 or even slid into a space between inner tube 1916 and outer tube 1912. The spacing material can act to reduce contact between the two tubes between which the insulating space is defined, as explained in the various references by Reid mentioned herein.

FIG. 19B provides further detail relating to an end of conduit 1900. As shown in FIG. 19B, a sealer ring 1928 can be disposed so as to seal insulating space 1914 of article 1900. (As described elsewhere herein, insulating space 14 can be evacuated to, e.g., from 10⁻⁵ to 10⁻⁹ Torr, e.g., about 10⁻⁶ or even 10⁻⁷ Torr.) Sealer ring 1928 can be ring-shaped as shown in FIG. 19B. As shown in FIG. 19B, sealer ring 1928 can be flush or nearly flush with an end of inner tube 1916 or outer tube 1912, though this is not a requirement. In some embodiments, a portion of sealer ring 1928 can extend beyond an end of inner tube 1912 or outer tube 1916. As one example, sealer ring 1928 can include a flange portion (not shown) that can be used as a gripping surface to facilitate placement of sealer ring 1928.

FIG. 19C provides a magnified view of region R in FIG. 19B. As shown in FIG. 19C, sealer ring 1928 is disposed within insulating space 1914 (not labeled) so as to seal that insulating space. In the exemplary embodiment of FIG. 19C, sealer ring 1928 is sealed to inner tube 1916 at joint 1940 and also sealed to outer tube 1912 at joint 1928. One or both of joint 1940 and joint 1928 can be a brazed joint.

In the exemplary embodiment of FIG. 19C, sealer ring 1928 has a V-shaped cross section, and sealer ring 1928 includes a first sloped portion 1930 that leads from land 1934 to joint 1938, extending toward first end 1942 of outer tube 1912. Sealer ring 1928 can include a second sloped portion 1932 that leads from land 1934 to joint 1940, in the direction of first end 1944 of inner tube 1916. As shown, land 1934 is flat, but land 1934 can be curved or otherwise nonplanar. It should also be understood that land 1934 is not a requirement, as sealer ring 1928 can include two sloped portions that extend from a point. Sloped portion 1932 can be inclined at an angle θ₂ relative to inner tube 16. θ₂ can be from about 0 to about 90, 120, or even 180 degrees, including all intermediate values and ranges. Sloped portion 30 can be inclined at an angle θ₁ relative to inner tube 16. θ₁ can be from about 0 to about 90, 120, or even 180 degrees, including all intermediate values and ranges. Either (or even both) of angles θ₁ and θ₂ can be 0 degrees.

It should be understood, however, that sealer ring 28 need not include planar sloped portions 1930 and 1932 as shown in FIG. 19C. Sealer ring 1928 can include one or more curved portions that act to encourage movement of molecules out of insulating space 1914. Some exemplary vacuum-insulated vents and structures (and related techniques for forming and using such structures) can be found in United States patent application publications 2017/0253416, 2017/0225276, 2017/0120362, 2017/0062774, 2017/0043938, 2016/0084425, 2015/0260332, 2015/0110548, 2014/0090737, 2012/0090817, 2011/0264084, 2008/0121642, and 2005/0211711, all by A. Reid, and all incorporated herein by reference in their entireties for any and all purposes. It should be understood that a vacuum (i.e., any vacuum within the disclosed devices and methods) can be effected by the methods in the aforementioned applications or by any other method known in the art.

As shown in FIG. 19C, sealer ring 1928 can optionally include a groove 1936, which groove can run circumferentially about sealer ring 1928. The groove can be used to facilitate positioning of sealer ring 1928 in conduit 1900.

Groove 1936 can be configured to extend the heat path between the walls 1916 and 1912. This extended heat path in turn reduces the transmission of thermal energy between walls 1916 and 1912. It should be understood that sealer ring 1928 can include one, two, or more grooves or other features configured to extend the length of the heat path between walls 1916 and 1912. The extended heat path can also allow for increased convection cooling of the heat transiting the extended heat path. (The foregoing is exemplary only, and one skilled in the art can determine other configurations to extend the heat path between the walls to achieve a similar result.)

Sealer ring 1928 can comprise a ceramic material, e.g., mica, oxides of silicates; it can also comprise aluminum or other materials. Without being bound to any particular theory, the use of a ceramic material in sealer ring 28 can reduce heat transfer from outer tube 1912 and inner tube 1916. This heat transfer provided by these materials can be in the range of, e.g., 0.05-8 Watts/meter Kelvin. This is significantly lower than materials such as stainless steel. The sealer ring can be selected so that it has a heat transfer coefficient less than the heat transfer coefficient of one or both of walls bridged by the sealer ring. In some embodiments, sealer ring 1928 comprises a ceramic, and one or both of inner tube 1916 and outer tube 1912 comprise a metal. As an example, sealer ring 1928 can be of a ceramic material, and both of inner tube 1916 and outer tube 1912 can be stainless steel. As another example, one or both of inner tube 1916 and outer tube 1912 can comprise a ceramic.

Sealer ring 1928 can be joined (e.g., via brazing or other process) directly to one or both of inner tube 1916 and outer tube 1912. It is not a requirement, however, that sealer ring 1928 be joined directly to one or both of inner tube 1916 and outer tube 1912, as sealer ring 1928 can be affixed generally so as to seal insulating space 1914. For example, a spacer ring (not shown) can be affixed to outer tube 1912, and sealer ring 1928 can be affixed to that ring. A sealer ring can be joined to another component via brazing, e.g., by use of an active braze paste.

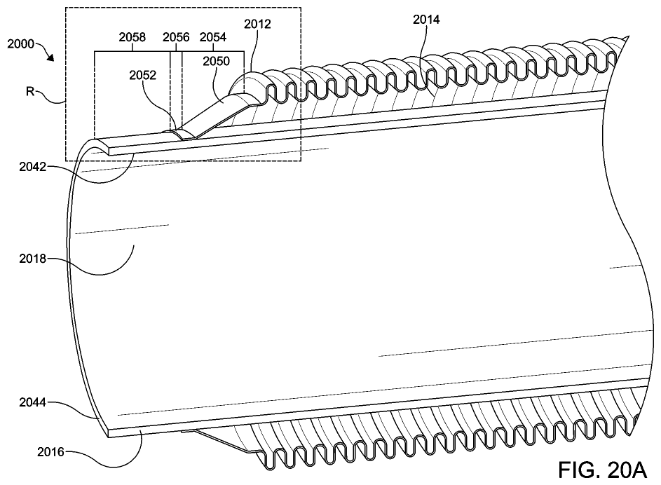

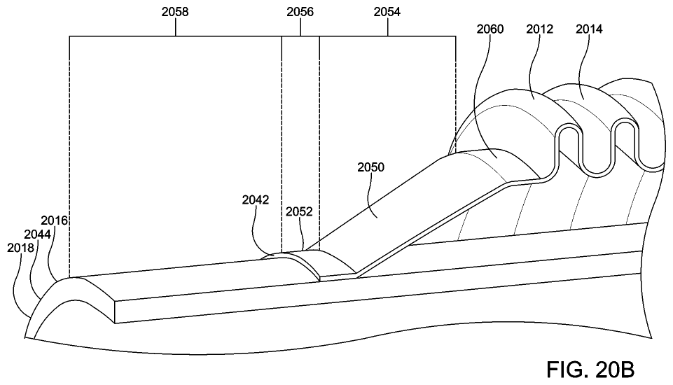

Exemplary FIG. 20A provides another embodiment of the disclosed conduits. As shown in FIG. 20A, an insulated conduit 2010 can include an outer tube 2012, which outer tube include a plurality of corrugations. The corrugations can be present along any portion of the length of the outer tube 2012. (It should be understood that although the corrugations shown in the disclosed FIGs. are arcuate in nature, corrugations can be v-shaped or even include one or more right angles in cross-section.) The conduit can also include inner tube 16, which inner tube further defines a lumen 2018. As explained elsewhere herein, however, it is not a requirement that the outer tube be corrugated. In some embodiments, the outer tube is free of corrugations, and the inner tube comprises a corrugated region. It should be understood that in some embodiments, both the outer wall and the inner wall are corrugated. The corrugations can be of the same period and/or height, but this is not a requirement, as an article according to the present disclosure can have an outer wall with corrugations that have a greater or lesser distance between individual corrugations than the distance between corrugations in the inner wall. Similarly, an article according to the present disclosure can have an outer wall with corrugations that have a greater or lesser height than the height of the corrugations in the inner wall.

Outer tube 2012 can be sealed to inner tube 2016 so as to define sealed insulating space 2014. As shown in FIG. 20A, outer tube 12 can include a sloped region 2050, having a length 2054. Sloped region 2050 can extend toward inner tube 2016, as shown. Outer tube 2012 can further include a joint land 2052 (having a length 2056), which joint land extends from sloped region 50 toward end 52 of outer tube 2012. Joint land 2052 can be sealed (e.g., via brazing) to inner tube 2016. In some embodiments, a length 2058 of inner tube 2016 can extend beyond the end of the outer tube's joint region 2052, in the direction of the end 2044 of inner tube 2016.

Additional detail is provided in FIG. 20B, which provides a magnified view of region R in FIG. 20A. As shown in FIG. 20B, outer tube 2012 can include corrugations (not labeled). Outer tube 2012 can optionally include a transition region 2060, which transition region extends toward sloped region 2050, so as to connect sloped region 2050 to a corrugated region of outer tube 2012. (It should be understood that transition region 60 is not a requirement, as sloped region 2050 can connect directly to a corrugation.) As shown, sloped region 2050 can extend for a distance 2054.

As shown in FIG. 20B, sloped region 2050 can extend toward inner tube 16, in the direction of end 2044 of inner tube 2016. Outer tube 2012 can include a joint land 2052, which joint land can extend for a distance 2056. At least a portion of joint land 2052 can be brazed or otherwise sealed to inner tube 2016; e.g., via vacuum brazing. The seal between outer tube 2012 and inner tube 2016 thus forms a vent; such vents are described elsewhere herein.

Sloped region 2050 can act as a vent, when insulating space 2014 is sealed. As described elsewhere herein, some exemplary vacuum-insulated vents and structures (and related techniques for forming and using such structures) can be found in United States patent application publications 2017/0253416, 2017/0225276, 2017/0120362, 2017/0062774, 2017/0043938, 2016/0084425, 2015/0260332, 2015/0110548, 2014/0090737, 2012/0090817, 2011/0264084, 2008/0121642, and 2005/0211711, all by A. Reid, and all incorporated herein by reference in their entireties for any and all purposes. It should be understood that a vacuum (i.e., any vacuum within the disclosed devices and methods) can be effected by the methods in the aforementioned applications or by any other method known in the art.

As described elsewhere herein, inner tube 2016 and/or outer tube 2012 can include one or more bends. In addition, although the exemplary embodiment of FIG. 20A and FIG. 20B shows a sloped portion of outer tube 2012 converging toward inner tube 2016, the present disclosure also includes embodiments in which inner tube 16 include a portion that diverges or flares outward toward outer tube 2012, so as to form a vent.

One or more of outer tube 2014, transition region 2060 (if present), sloped region 2050, and joint land 2052 can be configured so as to “spring into” inner tube 2016. As one example, the outer diameter of inner tube 2016 can be larger (e.g., larger by less than about 20, 15, 10, 5, or even 1%) than the inner diameter of outer tube 2012 (e.g., the inner diameter of outer tube 2012 at end 2042 and/or at joint land 2052). In this way, outer tube 2012 can act to at least partially secure itself to inner tube 2016 by effectively squeezing itself around inner tube 2016, e.g., by flexing of a portion of outer tube 2012 that converges or flares inward toward inner tube 2016. This in turn acts to secure outer tube 2012 to inner tube 2016.

By reference to FIG. 20A and FIG. 20B, the joint land 2052 limits the flow from the inside of the vacuum space 2014 to the inside of the vacuum furnace when an article according to the present disclosure is processed in a vacuum furnace. This limitation means the gas passes from the inside of the vacuum space 2014 into the interior area of the vacuum furnace at an accelerated rate. Because in a vacuum furnace most of the heating occurs via radiation, the outer tube 2012 heats (and can expend) at a different rate than the inner tube 2044. This in turn causes the joint land 2052 to act as a heat activated pressure relief valve for the pressure within the vacuum space 2014. The heat activated pressure release valve 2052 can effect a rapid release of pressure from the vacuum space 2014 and causes differing flows to occur.

The joint land 2052 can also provide a Venturi effect when evacuating the vacuum space 2014. This Venturi effect works to help further evacuate the vacuum space 2014 beyond the vacuum level provided within the vacuum chamber providing the vacuum. The venturi effect created by feature 2052 can, in conjunction with feature 2050 for funneling of the molecules as described herein, combine to provide an ultra-hyper deep vacuum that exceeds the vacuum level within the vacuum chamber which creates the part.

The joint land 2052 can also give rise to a continuous flow (also known as a vicious flow) through the area. Vicious flow typically operates in a low vacuum environment. In a continuous flow there are frequent collisions between gas molecules, but less frequently with the walls of the vessel. In this case, the path of the gas molecules is significantly shorter than the dimensions of the flow channel. This continuous flow promoted by joint land 2052 also contributes to the development of a ultra-hyper deep vacuum in vacuum space 2014. The continuous flow provided by joint land 2052 is different from the laminar flow mentioned earlier in this disclosure.

Joint land 2052 also can help to evacuate the vacuum space 2014 through the use of turbulent flow in a vacuum. Turbulent flow occurs when the Reynolds number is greater than 4000. Turbulent flow typically occurs during rapid pump-down or when rapid venting occurs. Turbulent flow can occur along with laminar flow. Turbulent flow in this example occurs in the presence of a vacuum created in the vacuum chamber. The joint land 2052 provides the relatively high flow restriction needed to increase the turbulent flow of the gas escaping the vacuum space 2014.

The flow mechanics enabled by feature 2052 can provide the ultra-hyper deep vacuum within the vacuum space 2014. This feature 2052 is not limited to the corrugated configuration and can be used in any joint designed to evacuate a vacuum space to an ultra-hyper deep vacuum.

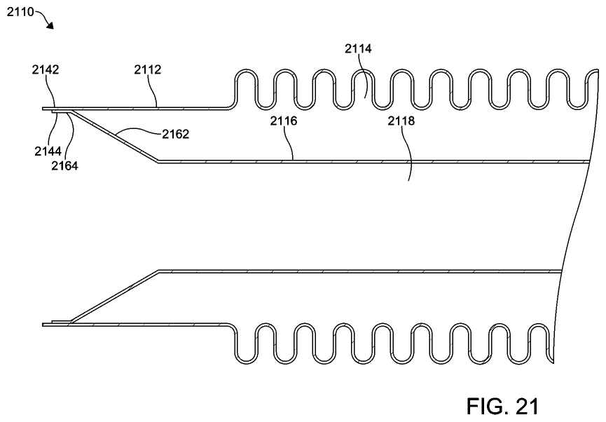

Likewise, inner tube 2016 can include a portion that diverges or flares toward outer tube 2012, so as to form a vent, as described elsewhere herein. In some such embodiments, the outer diameter of inner tube 2016 can be larger than the inner diameter of outer tube 2012, such that inner tube 2016 compresses itself against outer tube 2012. This can be accomplished by, e.g., flexing of the portion of inner tube 2016 that diverges or flares toward outer tube 12. This in turn acts to secure outer tube 2012 to inner tube 2016. One such embodiment is provided in exemplary FIG. 21 attached hereto. As shown in FIG. 21, insulated conduit 2110 includes outer tube 2112, which outer tube includes a plurality of corrugations (not labeled). Disposed within outer tube 2112 is inner tube 2116, which inner tube defines a lumen 2118. The outer tube and inner tube can be coaxial with one another, and can share a major axis (not shown).

As FIG. 21 provides, inner tube 2116 can include a sloped region 2162, which sloped region flares or diverges outward in the direction of outer tube 2112. Sloped region 2162 can connect to a joint land 2164, which joint land extends in the direction of the end 2144 of inner tube 2116 and in the direction of end 2142 of outer tube 2112. Inner tube 2116 and outer tube 2112 can be sealed together at at least a portion of joint land 2164; the sealing can be accomplished by brazing or other methods known to those of skill in the art.

The sealing at joint land 2164, nearby to sloped portion 2162 gives rise to a vent, which vent seals insulating space 2114, which insulating space is defined between inner tube 2116 and outer tube 2112. As described elsewhere herein, the outer diameter of inner tube 2116 can be greater at one location along the tube than the inner diameter of outer tube 2112, such that flexing of inner tube 2116 at least partially secures inner tube 2116 against outer tube 2112. The end 2142 of outer tube 2112 can extend beyond the end 2144 of inner tube 2116. This is, however, not a requirement, as the end of the inner tube can extend beyond the end of the outer tube. The ends of the inner and outer tubes can also be coterminal with one another.

The joint land 2164 can be configured to provide the benefits of continuous flow and turbulent flow (described above) when evacuating the vacuum space to a ultra-hyper deep vacuum.

It should be understood that an insulated conduit according to the present disclosure can have a proximal end and a distal end. One of both of the proximal and distal ends can be sealed according to the vents described herein. In embodiments where both the proximal and distal ends of the insulated conduit are sealed with vents according to the present disclosure, it is not a requirement that both vents be formed the same way. For example, the proximal end of an insulated conduit can be sealed with a sealing ring as shown in FIGS. 19A-19C, and the distal end of an insulated conduit can be sealed according to FIGS. 20A-20B or even according to FIG. 21.

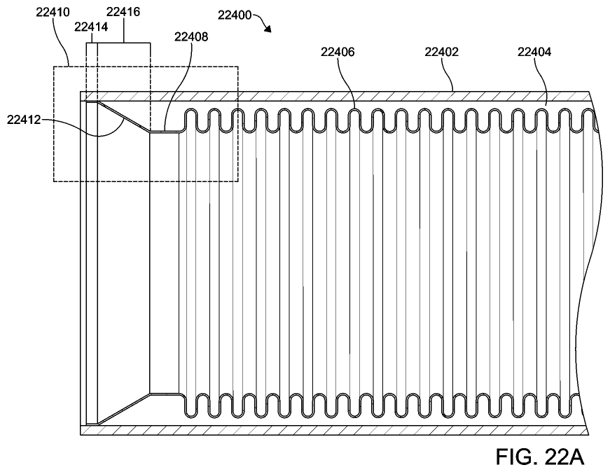

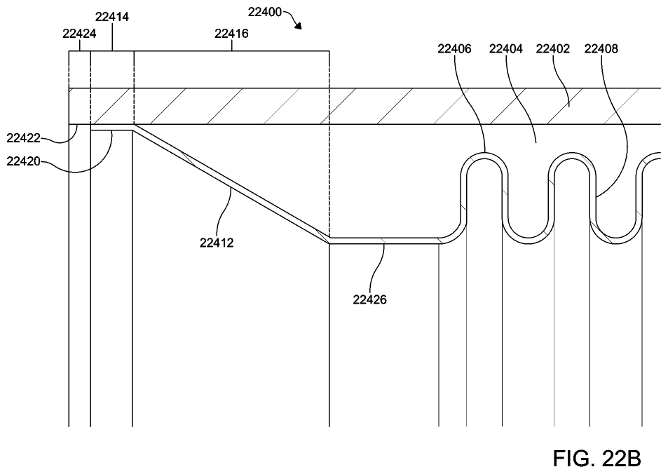

FIG. 22A provides a cutaway view of an illustrative embodiment according to the present disclosure of an insulated conduit 22400. As shown, insulated conduit 22400 can include outer tube 22402, which tube can be smooth, i.e., free of corrugations. Insulated conduit 22400 can also include inner tube 22408, which can include corrugations 22406. As shown, the inner and outer tubes can be sealed to one another so as to define a sealed insulating space 22404.

Inner tube 22408 can include sloped region 22412; as shown, angled region 22412 can flare outward toward outer tube 22402. Sloped region 22412 can define a length (along the major axis of inner tube 22408) 22416. As shown, inner tube 22408 can include a joint land region; the joint land region in FIG. 22A has a length of 22414. Region 22410 of insulated conduit is shown in FIG. 22B, described below.

FIG. 22B provides a magnified view of region 22410 in FIG. 22A. As shown in FIG. 22B, inner tube 22408 can include corrugations 22406. Inner tube 22408 and outer tube 22402 can define sealed insulating space 22404 therebetween.

Inner tube 22408 can include transition region 22426 that is connected to a corrugated region of inner tube 22408. Inner tube can further comprise sloped region 22412 that is connected to transition region 22426. Sloped region 22412 can be connected to joint land 22420. At least a portion of joint land 22420 can be sealed to outer tube 22402. Sloped region 22412 can have a length 22416. Similarly, joint land 22420 can have a length 22414. Outer tube 22402 can have an end region 22422 that extends beyond the end of joint land 22420; end region 22422 can have a length 22424. Methods of joining inner tube 22408 to outer tube 22402 are described elsewhere herein.

A spacer material (not shown or labeled) can optionally be disposed within sealed insulating space 22404 so as to reduce or even eliminate contact or so-called “thermal shorts” between inner tube 22408 and outer tube 22402. The spacer material can be, e.g., a ceramic, boron nitride, or other suitable material.

Without being bound to any particular theory, the embodiment shown in FIGS. 22A and 22B provides an alternative pathway to forming a non-straight, insulated conduit. Using a conduit according to FIG. 22A, a user can bend the conduit; such a conduit can be bent while maintaining the sealed insulating space 22404 between inner tube 22408 and outer tube 22402 without any physical contact between inner tube 22408 and outer tube 22402. A spacer material disposed within sealed insulating space 22404 can prevent contact between inner tube 22408 and outer tube 22404.

Without being bound to any particular theory, the corrugations in inner tube 22408 allow for bending without the tube experiencing crimping—this in turn allows the inner tube to bend within the outer tube while also maintaining sealed insulating space 22404. In this way, a user can produce an insulated conduit that has a smooth, non-corrugated outer surface. Such smooth-surfaced conduits can be well-suited for certain applications, e.g., applications where a user can desire a certain external appearance, such as visible exhaust pipes and the like. The corrugated tube configuration can be used as an inlet line or as an outlet line, e.g., in conjunction with a container, e.g., the containers shown in non-limiting FIGS. 1-4.

It should be understood that in an article having inner and outer tubes (also termed “walls”), the tubes can be concentric with one another. Either or both of the inner and outer walls can comprise corrugations. As described herein, corrugations can be uniform in height and/or pitch along the length of a wall, but this is not a requirement, as corrugations can vary in pitch and/or height along the length of a wall. When both inner and outer walls comprise corrugations, the corrugations of one wall can be the same in pitch and/or height as the corrugations of the other wall. This is not, however, a requirement, as the corrugations of one wall can differ in pitch and/or height relative to the corrugations of the other wall. A wall can include one or more corrugated portions and one or more non-corrugated portions.

Further, (a) an inner wall can flare outwards toward the outer wall, (b) the outer wall can converge/flare inwards toward the inner wall, or both (a) and (b). A wall having a sloped portion that converges/flares toward the other wall can further include a land portion connected to and extending from the sloped portion. The land portion of a first wall can be (as measured along an axis) parallel to the second wall, though this is not a requirement. By reference to non-limiting FIG. 22B, land portion 22420 of inner wall 22426 extends from sloped portion 22412 of inner wall 22426. Land portion 22420 extends parallel to outer wall 22402.

It should be understood that a land portion can form a non-zero angle with the sloped portion. The non-zero angle can be, e.g., from more than 0 to less than +180 degrees (relative to the sloped portion), or less than 0 to less than −180 degrees (relative to the sloped portion). The non-zero angle can be, e.g., more than 0 to about +45 degrees, or less than 0 to about −45 degrees.

The land portion of a wall can define a diameter of the wall (e.g., when the wall is tubular). The land portion of a first wall can define a diameter than differs from a diameter of the second wall. For example, if the outer wall includes a land portion, that land portion can define a diameter that is less than the outer diameter of the inner tube. That land portion can also define a diameter that is greater than the outer diameter of the inner tube; the land portion can also define a diameter that is the same as the outer diameter of the inner tube.

If the inner wall includes a land portion, that land portion can define a diameter that is greater than the inner diameter of the outer tube. That land portion can also define a diameter that is less than the inner diameter of the outer tube; the land portion can also define a diameter that is the same as the inner diameter of the outer tube. In some embodiments, both the inner wall and the outer wall can include sloped portions and land portions; the sloped portions can extend toward one another and the land portions can overlap one another.

As a non-limiting example illustrated by reference to exemplary FIG. 22B, land portion 22420 can define an outer diameter (not labeled) that is slightly greater than the inner diameter of outer wall 22402. In this way, land portion 22420 can press outward and against outer wall 22402 when inner wall 22426 and outer wall 22402 are assembled. As another example, land portion 22420 can define an outer diameter (not labeled) that is slightly less than the inner diameter of outer wall 22402. In this way, when inner wall 22426 and outer wall 22402 are assembled, there is a space between land portion 22420 and outer wall 22402. The space can be sealed by, e.g., a ceramic ring, a braze material, and the like.

An article can define a proximal end and a distal end, and the proximal ends of the inner wall and the outer wall can be coterminal with one another. In some embodiments, the proximal ends of the outer wall and the inner wall are at a distance (measured along a proximal-distal axis, e.g., an axis (coaxial axis) shared by the inner and outer walls) from one another. The proximal end of the inner tube can extend beyond the proximal end of the outer tube. The proximal end of the outer tube can extend beyond the proximal end of the inner tube. the distal ends of the inner wall and the outer wall can be coterminal with one another. In some embodiments, the distal ends of the outer wall and the inner wall are at a distance (measured along a proximal-distal axis, e.g., an axis (coaxial axis) shared by the inner and outer walls) from one another. The distal end of the inner tube can extend beyond the distal end of the outer tube. The distal end of the outer tube can extend beyond the distal end of the inner tube.

Although some embodiments illustrate the presence of a ring (e.g., a ceramic ring) that seals the ends of the inner and outer tubes, it should be understood that this is not a requirement, as the ring need not be present at the end of a tube and can be present at a location along a tube.

In some embodiments, the first wall (which can be a tube) has a first thermal conductivity, the second wall (which can be a tube) has a second thermal conductivity (which can be the same as the first thermal conductivity but can also differ from the first thermal conductivity), and a bridge material having a third thermal conductivity is disposed so as to form a seal between the first wall and the second wall. The third thermal conductivity can be lower than one or both of the first thermal conductivity and the second thermal conductivity. In this way (and without being bound to any particular theory of operation), the bridge material (which can be present as a ceramic ring, in some embodiments) acts as a “thermal resistor” between the first wall and the second wall, thus reducing heat transfer between the first wall and the second wall. As an example, an article can include a stainless steel first tube and a stainless steel second tube. A ceramic ring (as the bridge material) can then be sealed (e.g., via brazing) to the first tube and the second tube so as to give rise to a sealed space between the tubes.

The bridge material can be sealed to the first wall and the second wall under evacuated conditions, e.g., under a vacuum, although this is not a requirement.

As one example embodiment, a ceramic ring can be disposed partway along the lengths of a first tube and a second tube and then sealed to the first tube and the second tube so as to form a sealed space between the first tube and the second tube. The first tube can flare outwardly toward the second tube at the location of the bridge material joint between the first tube and the second tube and/or the second tube can converge inwardly toward the first tube at the location of the bridge material joint between the first tube and the second tube.

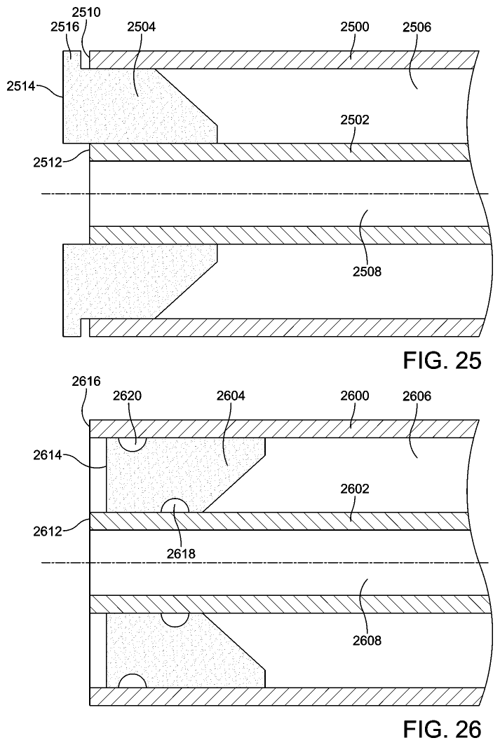

The bridge material can be shaped (e.g., beveled) so as to present an angle relative to one or both of the first and second walls. In some embodiments, the bridge material can comprise a flange or other projection. As shown in FIG. 25, the flange can be used to maintain the bridge material in position. It should be understood that the bridge material can be positioned at or near the end of a tube, but this is not a requirement, as the bridge material can be positioned at a location along the length of a tube.

The first wall and/or the second wall can include a groove formed therein so as to contain the bridge material or other material. The groove can serve to contain at least some of the bridging material and can also serve to disperse the bridging material (in solid, liquid, or semi-solid form), e.g., about the circumference of a tube. The bridging material can be present within a portion or within the entirety of the groove; in some embodiments, the bridging material can be processed (e.g., melted) to as to flow along and be distributed within the groove.

In some embodiments, the bridge material can comprise one or more grooves formed therein. The grooves can be in register with one another, but can also be offset from one another. A groove can be used to contain a bonding material, e.g., a braze material. For example, a ring of braze material can be disposed within a groove formed in the bridge material.

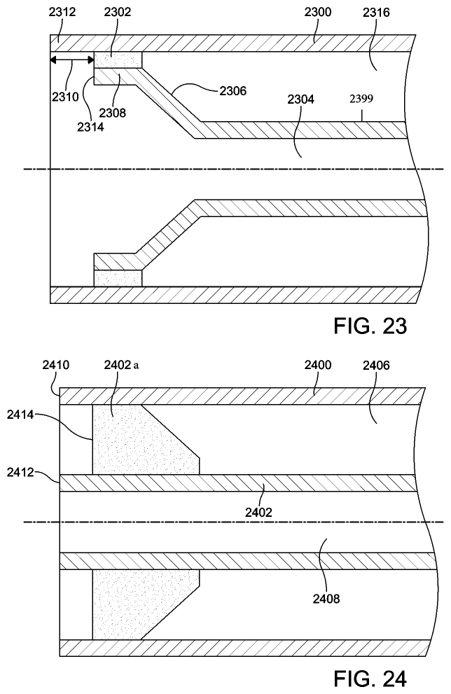

FIG. 23 provides an illustrative article. As shown, outer wall 2300 and inner wall 2399 define a sealed insulating space 2316 therebetween; the sealed insulating space can be at a reduced pressure. Inner wall 2302 can include a flared portion 2306 that extends in the direction of outer wall 2300. The end 2312 of outer wall 2300 can extend beyond the end 2314 of inner wall 2399, e.g., by a distance 2310. This is not a requirement, as the ends of the inner wall and the outer wall can be coterminal with one another. In some embodiments, the end of the inner wall 2399 can extend beyond the end 2312 of the outer wall 2300.

A bridge material 2302 (which can be, e.g., a ceramic) can be used to form at least part of the seal that defines the sealed insulating space 2316. Inner wall 2399 can include a land portion 2308. The flared portion 2306 of the inner wall 2399 can form a vent as described elsewhere herein. The article can define a lumen 2304 therein.

FIG. 24 provides another alternative embodiment of the disclosed technology. As shown, inner wall 2402 and outer wall 2400 define a sealed insulating space 2406 therebetween. A bridge material 2402a can be used to seal the aforementioned insulating space. As shown, the end 2410 of the outer wall 2400 can be coterminal with the end 2412 of inner wall 2401, though one of these two ends can extend beyond the other. (The inner wall 2401 can define a lumen 2408 therein.) As shown the bridge material 2402a can have an end surface 2414; the end surface can be coterminal with one or both of end 2410 or end 2412, but this is not a requirement. The end surface 24s14 of the bridge material 2402a can be at a distance from one or both of ends 2410, 2412. The bridge material 2402a can include a sloped region (not labeled), which sloped region can form an angled joint with the inner wall or outer wall. The bridge material 2402a can include a surface that is perpendicular to one or both of the inner wall and the outer wall, but the bridge material can also—as described elsewhere herein—include

FIG. 25 provides another alternative embodiment of the disclosed technology. As shown, inner wall 2502 and outer wall 2500 define a sealed insulating space 2506 therebetween. A bridge material 2504 can be used to seal the aforementioned insulating space. As shown, the end 2510 of the outer wall 2500 can be coterminal with the end 2512 of inner wall 2501, though one of these two ends can extend beyond the other. (The inner wall 2501 can define a lumen 2508 therein.) As shown, bridge material 2504 can include a flange 2516, which flange 2516 can extend beyond one or both of end 2510 or 2512; the flange can be used to maintain the bridge material in position. Also as shown, bridge material 2504 can contact outer wall 2500 and/or inner wall 2502.

FIG. 26 provides another alternative embodiment of the disclosed technology. As shown, inner wall 2602 and outer wall 2600 define a sealed insulating space 2606 therebetween. A bridge material 2604 can be used to seal the aforementioned insulating space. As shown, the end 2610 of the outer wall 2600 can be coterminal with the end 2612 of inner wall 2601, though one of these two ends can extend beyond the other. (The inner wall 2601 can define a lumen 2608 therein.) As shown, bridge material 2604 can have an outer surface 2614, which can be coterminal with one or both of end 2610 or 2612, but can also be located at a distance from one or both of the ends. The bridge material 2604 can include a groove; example grooves 2620 and 2618 are shown. A groove can be used to retain a material, e.g., a braze material or other material.

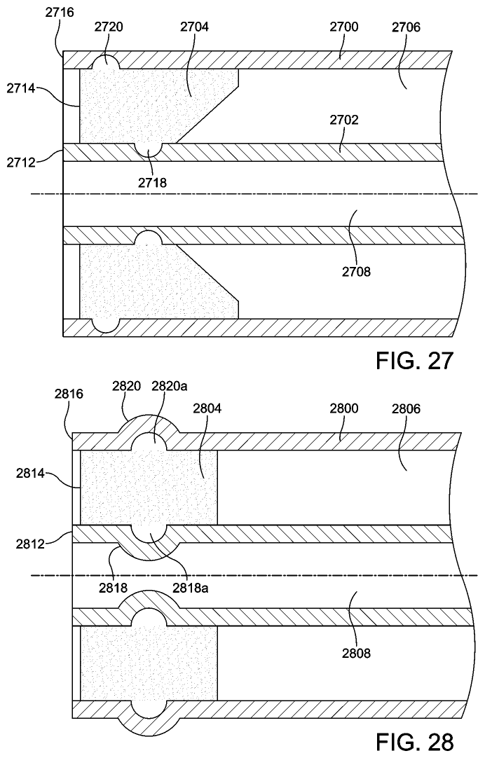

FIG. 27 provides another alternative embodiment of the disclosed technology. As shown, inner wall 2702 and outer wall 2700 define a sealed insulating space 2706 therebetween. A bridge material 2704 can be used to seal the aforementioned insulating space. As shown, the end 2710 of the outer wall 2700 can be coterminal with the end 2712 of inner wall 2701, though one of these two ends can extend beyond the other. (The inner wall 2701 can define a lumen 2708 therein.) As shown, bridge material 2704 can have an outer surface 2714, which can be coterminal with one or both of end 2710 or 2712 but can also be located at a distance from one or both of the ends. The inner wall and/or outer wall can include grooves; example grooves are shown by 2718 and 2720. A groove can be used to retain a material, e.g., a braze material or other material.

FIG. 28 provides another alternative embodiment of the disclosed technology. As shown, inner wall 2802 and outer wall 2800 define a sealed insulating space 2806 therebetween. A bridge material 2804 can be used to seal the aforementioned insulating space. As shown, the end 2810 of the outer wall 2800 can be coterminal with the end 2812 of inner wall 2801, though one of these two ends can extend beyond the other. (The inner wall 2801 can define a lumen 2808 therein.) As shown, bridge material 2804 can have an outer surface 2814, which can be coterminal with one or both of end 2810 or 2812, but can also be located at a distance from one or both of the ends. The inner wall and/or outer wall can include grooves; example grooves are shown by 2818 and 2820. A groove can be used to retain a material, e.g., a braze material or other material. Cavity 2820a formed by groove 2820 can be filled with bridge material 2804 (not shown), but this is not a requirement. Cavity 2818a formed by groove 2818 can be filled with bridge material 2804 (not shown), but this is not a requirement.

### Illustrative Embodiments

The following embodiments are illustrative only, and do not serve to limit the scope of the present disclosure or the attached claims.

Embodiment 1. A vacuum-insulated article, comprising: a first wall and a second wall; a first sealed insulating space formed between the first wall and the second wall, the insulating space defining therein a region of reduced pressure; a first vent communicating with the first insulating space to provide an exit pathway for gas molecules from the first insulating space, the first vent being sealable for maintaining a first vacuum within the first insulating space following evacuation of gas molecules through the first vent; a first seal sealing the first insulating space at the first vent; and at least one portion of a reflective material having a surface, the at least one portion of reflective material being disposed within the insulating space, the surface of the reflective material comprising boron nitride.

A reflective material is suitably a material that experiences little to no outgassing when processed, e.g., when heated, when subjected to vacuum, or even when processed in a vacuum furnace. Reflective materials that are ceramic in nature are considered suitable, but other non-ceramic materials can also be used. Such a material can be one that has been processed, e.g., via exposure to heat, vacuum, or both, such that contaminants of the material that can lead to outgassing have been removed. As on example of such a process, one can expose the material in question to a comparatively high temperature for several hours, e.g., a temperature below the degradation of the material or even a temperature (e.g., about 1700 or even about 1750 deg. F.) that is below the melting temperature of a brazing material.

A reflective material can be woven or nonwoven in nature. A fiber of a reflective fabric can have a cross-sectional dimension (e.g., a diameter) in the range of from about 0.005 to about 0.0020 inches. A single thread (i.e., a thread that makes up a fiber) can have a cross-sectional dimension in the range of from about 0.001 or about 0.002 inches, in some embodiments. Fibers can be wound and/or unwound so as to accommodate the needs of the user, e.g., a need to fit a winding of the fiber into a radial space of, e.g., about 0.004 or even about 0.005 inches.

The reflective material can extend along the entirety of the space between the first and second walls. For example, if the space between the first and second walls can be defined as a square region 10 cm by 10 cm, the space can be occupied by a piece of reflective material that is also 10 cm by 10 cm. The space can also be occupied by multiple pieces of reflective material.

The reflective material disposed in the insulating space can have effective dimensions that are up to 100% of the dimensions of the insulating space, but this is not a requirement, as reflective material disposed in the insulating space can have effective dimensions that are up to less than 100% of the dimensions of the insulating space. For example, an article can define an insulating space that is 10 cm by 10 cm, but that space is occupied by a piece of reflective material that is 9 cm by 9 cm. Multiple pieces of reflective material can be disposed in the insulating space between the first and second walls.

The reflective material can be one that has particular reflectance in the IR wavelength range, e.g., from about 1 to about 700 nm in wavelength. For example, a reflective material can be one that has reflectance for radiation having a wavelength in the range of, e.g., from about 0.5 to about 20 microns, e.g., from about 0.5 to about 10 microns. The reflective material can have a spectral average reflectance of, e.g., about 95%.

Embodiment 2. The article of embodiment 1, wherein the outer (e.g., second) and inner (e.g., first) walls are arranged in a concentric fashion. As one non-limiting example, the outer and inner walls can be arranged so as to form a double-walled tube. The cross-section (e.g., width) of the space between the first and first and second walls can be constant or nearly so (e.g., varying by less than about 10%) along the length of the first and second walls. In some embodiments, the cross-section of the space between the first and second walls can increase or decrease along the length of the first and second walls.

In some embodiments, the reflective material extends along the entirety of the circumference of the space between the concentric walls. In other embodiments, the reflective material extends along only a portion of the space between the concentric walls. Reflective material can be wound (e.g., in a spiral or helical fashion) within the insulating space between the first and second walls of an article.

As described elsewhere herein, two or more pieces of reflective material can be disposed within the insulating space. As one example, a first piece of reflective material can be disposed to cover the lower portion of the space between two concentric walls, and a second piece of reflective material can be disposed so as to cover the upper portion of the space between the two walls. Pieces of reflective material can be disposed so as to overlap one another, although this is not a requirement.

Embodiment 3. The article of embodiment 1, wherein the outer (e.g., second) and inner (e.g., first) walls are arranged in a parallel fashion. As one example, the first and second walls can be arranged as parallel plates. In such an embodiment, the article can define a planar insulating feature.

Embodiment 4. The article of any of embodiments 1-3, wherein one or both of the first and second walls is characterized as being bent. As one example, the first and second walls can be arranged such that they form an elbow structure. The bend can be a bend of anywhere from about 1 to about 90 degrees and all intermediate values. In some embodiments, the bend can be greater than about 90 degrees, e.g., from about 91 to about 180 degrees, and all intermediate values. A bend can be a sharp bend (e.g., a bend that includes a corner), or a more gradual bend. As one such example, an article can be characterized as being a straight or a bent tube.

Embodiment 5. The article of any of embodiments 1-4, further comprising a portion of a metallic sheeting material disposed within the insulating space. The metallic sheeting material can be, e.g., stainless steel or other metals (including metal alloys), e.g., a metal in foil form. The reflective material can be, e.g., aluminum, gold, silver, metallized polymeric film, or other low-emittance film. The metallic sheeting material can be one that can withstand the processing steps associated with forming the article.

Metallic sheeting material can have a thickness in the range of from, e.g., about 0.0001 to about 0.01 inches, from about 0.001 to about 0.1 inches or even from about 0.01 to about 0.05 inches. Sheets of metallic sheeting material having a thickness of about 0.0005 inches are considered especially suitable. A metallic sheeting material is suitably reflective in the infrared range. In some embodiments, the sheeting material can have an emissivity of less than about 0.4, 0.3, 0.2, 0.15, 0.1, 0.09, 0.08, 0.07, 0.06, 0.05, 0.04, 0.03, 0.02, or even lower for wavelengths in the range of from about 0.2 or 3 micrometers to about 50, to about 45, to about 40, to about 35, to about 30, to about 25, or even to about 15 or 16 micrometers.

A metallic sheeting material can have a coating disposed thereon. Suitable coatings can be reflective and/or non-stick coatings. A coating on a reflective material can be smooth, but can also be patterned or otherwise non-flat so as to prevent sticking or friction between the reflective material and any adjacent components. As one example, dots, stripes, hexagons, triangles, or other patterned shapes can be printed onto the reflective material. Ceramic pastes are considered especially suitable materials for printing onto reflective materials.

A metallic sheeting material can be smooth in profile, but can also itself be patterned, e.g., dimpled, crinkled, perforated, wrinkled, or otherwise roughened. The pattern can be selected to reduce the amount of rubbing and/or sticking between the material and other neighboring surfaces. In some embodiments, the metallic sheeting material can be present as a single layer. In other embodiments, the metallic sheeting material can be present in multiple layers, which can be termed multi-layer insulation (MLI).

A metallic sheeting material is suitably a material that experiences little to no outgassing when processed, e.g., when heated, when subjected to vacuum, or even when processed in a vacuum furnace.

Embodiment 6. The article of any of embodiments 1-5, wherein the reflective material comprises a ceramic fiber.

Embodiment 7. The article of any of embodiments 1-6, wherein the reflective material comprises alumina, silica, or both.

Embodiment 8. The article of embodiment 7, wherein the reflective material comprises alumina.

Embodiment 9. The article of any of embodiments 5-8, wherein the metallic sheeting material is disposed between at least two portions of reflective material. As one example, the metallic sheeting material can be sandwiched between two portions of reflective material.

Embodiment 10. The article of any of embodiments 5-9, wherein the reflective material is disposed between at least two portions of metallic sheeting material. As one example, the reflective material can be sandwiched between two portions of metallic sheeting material.

It should be understood that a reflective material and a metallic sheeting material can be separate from one another, i.e., not joined or otherwise adhered to one another. This, however, is not a requirement, as reflective material can be attached (e.g., welded, stitched, bonded) to a metallic sheeting material. This can, in some embodiments, simplify or otherwise facilitate fabrication of articles, as a user can assemble an article according to the present disclosure by inserting (and/or winding, depending on the construction of the article) a single integrated portion of material that comprises a region of reflective material and also a region of metallic sheeting material. Such an integrated portion of material will in turn possess the properties of the reflective material as well as the properties of the metallic sheeting material. Without being bound to any particular theory or embodiment, this approach allows for a wound portion of material that has, on its outside, reflective material, which reflective material can be non-stick or low-friction in nature by virtue of the boron nitride present on the surface of the material. At the same time, the integrated portion of material will enjoy the reflective characteristics of the metallic sheeting material.

In one particular embodiment, an integrated portion of material can include a region of reflective material, a region of metallic sheeting material, and another region of reflective material in an A-B-A—type pattern. Again without being bound to any particular theory or embodiment, this approach allows for a wound portion of material that has, on its outside, reflective material, which reflective material can be non-stick or low-friction in nature by virtue of the boron nitride present on the surface of the material. At the same time, the integrated portion of material will enjoy the reflective characteristics of the metallic sheeting material. The inside portion of the wound material will then, in turn, comprise a portion of reflective material, which can be non-stick or low-friction in nature by virtue of the boron nitride present on the surface of the material.

In some embodiments, an article can be constructed such that reflective material is adjacent to the walls that define an insulating space of the article. Metallic sheeting material can be disposed within the space, and can be disposed such that the metallic sheeting material does not contact the walls that define the insulating space of the article.

Embodiment 11. The article of any of embodiments 1-10, wherein the reflective material is characterized as being attached to itself along an edge of the reflective material. Without being bound to any particular theory, this can be effected so as to give rise to a rolled, cylindrical portion of reflective material.

Embodiment 12. The article of Embodiment 11, wherein the reflective material is characterized as attached to itself by one or more stitch welds. Stitch welding will be known to those of skill in the art.

Embodiment 13. The article of Embodiment 1, wherein the portion of reflective material is characterized as being spiral in form. As one example, a portion of reflective material can be pre-formed into a spiral (which includes a helical configuration) configuration before insertion into a space defined between concentric walls.

Embodiment 14. The article of any of Embodiments 1-13, further comprising a third wall disposed such that the second (e.g., outer) wall is between the first (e.g., inner) and third walls (e.g., outermost).

Embodiment 15. The article of Embodiment 14, further comprising a second insulating space disposed between the second and third walls. The second insulating space is suitably sealed against the environment exterior to the second insulating space.

Embodiment 16. The article of Embodiment 15, further comprising a portion of reflective material disposed within the second insulating space, the surface of the reflective material comprising boron nitride. The second insulating space can also comprise therein a metallic sheeting material; suitable such materials are described elsewhere herein. Multiple portions of reflective material, metallic sheeting material, or both, can be disposed within the second insulating space.

Embodiment 17. An article, comprising: first and second walls defining a sealed vacuum space disposed therebetween; and at least one portion of a reflective material disposed within the sealed vacuum space, the surface of the reflective material comprising boron nitride.

Embodiment 18. The article of Embodiment 17, wherein at least one of the first and second walls comprises stainless steel.

Embodiment 19. The article of any of Embodiments 17-18, wherein at least a portion of the first and second walls are parallel to one another.

Embodiment 20. The article of any of Embodiments 17-19, wherein at least one of the first and second walls is curved. As one example, the first and second walls can be arranged such that they form an elbow structure. The bend can be a bend of anywhere from about 1 to about 90 degrees and all intermediate values. In some embodiments, the bend can be greater than about 90 degrees, e.g., from about 91 to about 180 degrees, and all intermediate values. A bend can be a sharp bend (e.g., a bend that includes a corner), or a more gradual bend.

Embodiment 21. The article of any of Embodiments 17-20, further comprising a metallic sheeting material disposed adjacent to the first wall, disposed adjacent to the second wall, or both. Suitable metallic sheeting is described elsewhere herein.

Embodiment 22. The article of any of Embodiments 17-21, further comprising a third wall disposed such that the second wall is between the first and third walls.

Embodiment 23. The article of Embodiment 22, further comprising a second insulating space disposed between the second and third walls. The second insulating space is suitably sealed against the environment exterior to the second insulating space.

Embodiment 24. The article of Embodiment 23, further comprising a portion of the reflective material disposed within the second insulating space.

Embodiment 25. The article of any of Embodiments 1-24, wherein the first insulating space has a pressure of from about 1×10⁻⁴ to about 1×10⁻⁸ Torr, e.g., from about 10⁻⁴ to about 10⁻⁸ Torr, or from about 10⁻⁵ Torr to about 10⁻⁷ Torr, or even about 10⁻⁶ Torr.

Embodiment 26. The article of any of Embodiments 1-25, wherein the first insulating space is oxide-free. (Similarly, the second insulating space—when present—can also be oxide-free.)

Embodiment 27. The article of any of Embodiments 1-26, wherein the reflective material disposed within the first insulating space is oxide-free.

Embodiment 28. An electronics component, comprising an article according to any of Embodiments 1-27.

Suitable such components include, e.g., probes, antennae, insulators (such as insulating sleeves and insulating plates), cabinets, housings, and the like.

Embodiment 29. A method, comprising: disposing at least one portion of a reflective material in a space between two walls, the surface of the reflective material comprising boron nitride; and giving rise to a sealed vacuum within said space. The reflective material is suitably confined to the space between the two walls. In one exemplary embodiment, the reflective material is wound into a cylinder that is disposed between the two walls. In another embodiment, a tube of metallic sheeting is formed by winding the metallic sheeting about itself and then spot-welding the metallic sheeting to itself so as to form a tube. The boron nitride material can then be confined within the interior of the metallic sheeting tube, and then placed between the two walls. In one embodiment, the boron nitride material and the metallic sheeting are wrapped about a first tube (i.e., first wall) and then a second tube is positioned such at the boron nitride material and metallic sheeting are disposed between the first and second tubes. The first and second tubes can then be sealed to one another so as to define a sealed space therebetween, within which space the boron nitride material and metallic sheeting are disposed. It should be understood that the space between two walls can include one or more layers of boron nitride material, as well as zero, one, two, or more layers of metallic sheeting. The boron nitride material and metallic sheeting can be arranged in an alternating fashion.

The reflective material can be pre-formed into a shape (e.g., spiral, curved shell) that is complementary to the shape of the space into which the reflective material is disposed.

The sealed vacuum can be effected by, e.g., a vacuum furnace. The various other documents cited herein provide exemplary description of forming a sealed vacuum.

Embodiment 30. The method of Embodiment 29, comprising disposing one or more portions of metallic sheeting material in the sealed vacuum space. The metallic sheeting material can be pre-formed into a shape (e.g., spiral, curved shell) that is complementary to the shape of the space into which the material is disposed.

Embodiment 31. The method of Embodiment 29, wherein the method gives rise to an article according to any of Embodiments 1-27.

Embodiment 32. A vacuum-insulated vessel, comprising: a first wall and an second wall defining an first insulating space of reduced pressure disposed between the first and second walls; the second wall enclosing the first wall and the first wall enclosing and defining a storage volume; a first conduit disposed so as to place the storage volume into fluid communication with the environment exterior to the vessel; and a first vent communicating with the first insulating space to provide an exit pathway for gas molecules from the first insulating space, the first vent being sealable for maintaining a first vacuum within the first insulating space following evacuation of gas molecules through the first vent; a first seal sealing the first insulating space at the first vent; and at least one portion of reflective material disposed within the first insulating space, the surface of the reflective material comprising boron nitride.

Embodiment 33. The vessel of Embodiment 32, wherein at least one of the first and second walls comprises a curvilinear region.

Embodiment 34. The vessel of any of Embodiments 32-33, wherein at least one of the first and second walls comprises a linear region.

Embodiment 35. The vessel of any of Embodiments 32-34, wherein the storage volume is sealed against the environment exterior to the vessel.

Embodiment 36. The vessel of any of Embodiments 32-35, wherein the first conduit comprises a first conduit wall and a second conduit wall, the first and second conduit walls defining therebetween an insulating conduit space of reduced pressure.

Embodiment 37. The vessel of Embodiment 36, wherein the first conduit comprises a first vent communicating with the insulating conduit space so as to provide an exit pathway for gas molecules from the insulating conduit space, the first vent being sealable for maintaining a first vacuum within the insulating conduit space following evacuation of gas molecules through the first vent, the first conduit further comprising a first seal sealing the first insulating space at the first vent.

Embodiment 38. The vessel of any of Embodiments 32-37, further comprising a baffle wall, the baffle wall being disposed within the first wall of the vessel, the baffle wall at least partially enclosing the storage volume, and the baffle wall and the first wall of the vessel defining a spillover volume therebetween, the spillover volume being capable of fluid communication with the storage volume.

Embodiment 39. The vessel of Embodiment 38, further comprising a stop flow device configured to interrupt fluid communication between the storage volume and the spillover volume. Such a device can be, e.g., a valve or other like device.

Embodiment 40. The vessel of Embodiment 39, further comprising a spillover conduit, the spillover conduit comprising a first spillover conduit wall and a second spillover conduit wall, the first and second spillover conduit walls defining therebetween an insulating spillover conduit space, which space can be of reduced pressure.

Embodiment 41. The vessel of Embodiment 40, wherein the spillover conduit comprises a first vent communicating with the insulating spillover conduit space so as to provide an exit pathway for gas molecules from the insulating spillover conduit space, the first vent being sealable for maintaining a first vacuum within the insulating spillover conduit space following evacuation of gas molecules through the first vent, the first spillover conduit further comprising a first seal sealing the first insulating space at the first vent.

Embodiment 42. The vessel of any of Embodiments 32-41, further comprising a jacket material that encloses the vessel.

Embodiment 43. The vessel of Embodiment 42, wherein the jacket material contacts the second wall of the vessel.

Embodiment 44. The vessel of any of Embodiments 42-43, wherein the jacket material comprises a woven composite, a braided composite, a non-woven composite, or any combination thereof. Padded jacket materials are also considered suitable, as are scratch-resistant jacket materials.

Embodiment 45. The vessel of any of Embodiments 42-44, wherein the jacket material encloses at least 50% of the surface area of the vessel.

Embodiment 46. The vessel of any of Embodiments 32-45, further comprising a fluid disposed within the storage volume. Suitable fluids include, e.g., fuels, coolants, industrial gases, and the like.

Embodiment 47. The vessel of Embodiment 46, wherein the fluid comprises hydrogen.

Embodiment 48. The vessel of any of Embodiments 32-47, further comprising a heat source in thermal communication with the storage volume.

Embodiment 49. A method, comprising: disposing an amount of a fluid into the storage volume of a vessel according to any of Embodiments 32-48.

Embodiment 50. The method of Embodiment 49, wherein the fluid comprises hydrogen. Virtually any other fluid can be disposed into the storage volume, e.g., a fuel, a coolant, an industrial gas, and the like.

Embodiment 51. A method, comprising: removing an amount of a fluid from the storage volume of a vessel according to any of Embodiments 32-48.

Embodiment 52. A method, comprising: removing an amount of a fluid from the spillover volume of a vessel according to Embodiment 38.

Embodiment 53. The method of any of Embodiments 51-52, wherein the fluid comprises hydrogen.

Embodiment 54. An insulated article comprising: a first wall bounding an interior volume; a second wall spaced at a distance from the first wall to define an insulating space therebetween, at least one of the first and second walls comprising a ceramic material, the first and second walls being of the same or different materials; and a vent communicating with the insulating space to provide an exit pathway for gas molecules from the space, the vent being sealable for maintaining a vacuum within the insulating space following evacuation of gas molecules through the vent, the distance between the first and second walls being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress.

The first and second walls can be formed of the same or different materials. As one example, both the first and second walls can be formed of alumina. In another example, the first wall is formed of alumina, and the second wall is formed of zirconia.

The converging portion of a wall can be adjacent to an end of the associated wall. In some embodiments; the converging portion of a wall can even terminate at an end of the associated wall. In some embodiments, the converging portion of a wall can terminate at a distance from an end of the associated wall.

Embodiment 55. The insulated article according to Embodiment 54, wherein one of the walls includes a portion that converges toward the other wall adjacent the vent, and wherein the distance between the walls is at a minimum adjacent the location at which the vent communicates with the insulating space. As explained elsewhere herein, the converging portion can be present in the inner or outer of the two walls.

It should be understood that the term “converging” means to approach. As one example, in FIG. 1, the angled portion 20 of tube 14 approaches (i.e., converges towards) tube 12. Thus, in this embodiment, the inner diameter of tube 14 is reduced along the length of the portion of the tube where the tube 14 approaches tube 12.

In one embodiment, the inner of the two tubes can flare outwards (i.e., having an increasing outside diameter) toward the outer of the tubes, thus forming a vent between the two tubes. The inner tube can be said to be converging toward the outer tube.

As described elsewhere herein, FIG. 10 provides a view of this alternative embodiment. As shown in that figure, an insulated article can include inner tube 1002 and outer tube 1004, which tubes define insulating space 1008 therebetween. Inner tube 1002 also defines a lumen within, which lumen can have a cross-section (e.g., diameter) 1006. Insulating space 1008 can be sealed by sealable vent 1018. As shown in FIG. 10, inner tube 1002 can include a portion 1020 that flares outward toward outer tube 1004, so as to converge towards outer tube 1004.

Embodiment 56. The insulated article according to Embodiment 54, wherein the first and second walls are provided by first and second tubes arranged substantially concentrically to define an annular space therebetween. The first and second tubes can be separated by, e.g., 0.004 to 0.010 inches, in some non-limiting embodiments.

Embodiment 57. The insulated article according to Embodiment 56, wherein the converging wall portion of the one of the walls is located adjacent an end of the associated tube.

Embodiment 58. The insulated article according to Embodiment 56, wherein the wall including the converging portion is provided by an outer one of the tubes.

Embodiment 59. The insulated article according to Embodiment 56 further comprising a coating disposed on a surface of the one of the walls, the coating formed by a material having an emissivity that is less than that of the wall on which it is disposed.

Embodiment 60. The insulated article according to Embodiment 54, further comprising a material disposed between the first and second tubes so as to reduce direct contact between the first and second tubes. Such a material is suitably one that has a comparatively low thermal conductivity; in some embodiments, the material can have a thermal conductivity that is lower than the thermal conductivity of one or both of the walls separate by the material.

The material can be present as a sheet (e.g., a film) or a fabric (woven or non-woven). The material can also be present as a strip or even as a winding, e.g., as a thread, yarn, or fiber that is wound about the inner of the tubes.

Embodiment 61. The insulated article according to Embodiment 60, wherein the material comprises a winding of yarn.

Embodiment 62. The insulated article according to Embodiment 60, wherein the material comprises a reflective material.

Embodiment 63. The insulated article according to Embodiment 60, wherein the material comprises a ceramic.

Embodiment 64. The insulated article according to Embodiment 56, further comprising: a third tube located within the insulating space between the first and second tubes, the third tube being arranged substantially concentric to the first and second tubes. The third tube can comprise a ceramic material. The third tube can be comprised of a material that is the same or different from the material of the first and/or second tubes.

Embodiment 65. The insulated article according to Embodiment 54, wherein the article is a container and wherein the first wall defines a substantially rectangular storage space.

Embodiment 66. The insulated article according to Embodiment 55, wherein the vent is defined by an opening in one of the walls and wherein a portion of the other of the walls opposite the vent is arranged such that a tangent line at each location within the portion of the other of the walls is directed substantially towards the vent.

Embodiment 67. The insulated article according to Embodiment 66, wherein the article is a Dewar including an upper substantially cylindrical portion and a lower substantially spherical portion and wherein an opening of the vent is formed in an outer one of the walls in the lower portion, an inner one of the walls being indented opposite the vent.

Embodiment 68. A method of insulating an article, comprising: with first and second walls spaced at a distance from each other to define an insulating space therebetween, the distance between the walls being variable in a portion of the insulating space, at least one of the first and second walls comprising a ceramic material, and with a vent in communication with the insulating space to provide an exit pathway for gas molecules from the insulating space, the vent located proximate to the variable distance portion of the insulating space such that gas molecules are guided towards the vent during evacuation of the insulating space to facilitate their egress from the insulating space, and the vent being sealable for maintaining a vacuum within the insulating space; subjecting an exterior of the first and second walls to a vacuum to evacuate the insulating space, the facilitated egress of gas molecules provided by the variable distance portion of the insulating space increasing the probability of gas molecule egress from the space rather than ingress such that a deeper vacuum is generated within the insulating space than the vacuum to which the exterior is subjected; and sealing the vent to maintain the deeper vacuum within the space.

Embodiment 69. A cooling device, comprising: an outer jacket including a substantially cylindrical first portion and a substantially semi-spherical second portion; a first tube received by the first portion of the outer jacket and located substantially concentric thereto to define an insulating space therebetween, at least one end of the first tube forming a sealable vent with an inner surface of the outer jacket for maintaining a vacuum within the insulating space following evacuation of gas molecules through the vent, the distance between the first tube and the inner surface of the outer jacket being variable in a portion of the insulating space adjacent the vent such that gas molecules within the insulating space are directed towards the vent by the variable-distance portion during evacuation of the insulating space, thereby imparting to the gas molecules a greater probability of egress from the insulating space than ingress; and a second tube received by the first tube and located substantially concentric thereto to define a gas inlet therebetween, at least one of the first tube, the second tube, and the outer jacket comprising a ceramic material.

Embodiment 70. The cooling device according to Embodiment 69, wherein an annular pathway is defined between the first and second tubes adjacent the second portion of the outer jacket for passage of a gas from the gas inlet to an expansion chamber defined by the second portion of the outer jacket.

Embodiment 71. The cooling device according to Embodiment 69, wherein the second tube is secured to the first tube adjacent an end of the second tube and wherein the second tube includes at least one hole for passage of a gas from the gas inlet to an expansion chamber defined by the second portion of the outer jacket.

Embodiment 72. The cooling device according to Embodiment 69 further comprising a coating disposed on an inner surface of the second tube, the coating comprising a material having a relatively large thermal conductivity compared to the second tube.

Embodiment 73. The cooling device according to Embodiment 72 wherein the coating material is copper.

The foregoing describes the invention in terms of embodiments foreseen by the inventors for which an enabling description was available, notwithstanding that insubstantial modifications of the invention, not presently foreseen, can nonetheless represent equivalents thereto.

Embodiment 74. An insulated conduit, comprising: an outer tube having a first end and an inner tube having a first end, the inner tube defining a lumen, the inner tube being disposed within the outer tube so as to define a insulating space between the first tube and the second tube, the conduit further comprising a vent defined by a sealer ring having a first wall and a second wall, the second wall being disposed opposite the outer tube and the first wall being disposed opposite the inner tube, the sealer ring being disposed between one or both of the first end of the outer tube and the first end of the inner tube and the other tube so as to seal the insulating space to provide an exit pathway for gas molecules from the space, the vent being sealable for maintaining a vacuum within the insulating space following evacuation of gas molecules through the vent, (a) the distance between the second wall of the sealer ring and the outer tube and/or (b) the distance between the first wall of the sealer ring and the and the outer tube being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress, and the lumen of the inner tube comprising a first major axis at the first end of the inner tube, and the lumen comprising a bend, measured relative to the first major axis of from about 1 to about 180 degrees. The measurement can be in a single dimension, e.g., in the x-plane dimension.

The lumen can be, e.g., C-shaped, S-shaped, helical, or otherwise comprise one or more bends. As shown in exemplary FIG. 1A, the lumen can be shaped such that fluid entering the conduit along the major axis at the first end (44) of the lumen exits the lumen at the second end (48) of the lumen along an axis that does not intersect the major axis along which the fluid entered.

Embodiment 75. The insulated conduit of Embodiment 74, wherein the inner tube comprises two or more segments. Segments can be abutted or otherwise joined to one another.

Embodiment 76. The insulated conduit of any of Embodiments 74-75, wherein the inner tube (lumen) comprises at least two curves that curve in different dimensions from one another. As one example, an inner tube lumen can include a first bend of 45 degrees in the x-plane dimension at one location along the length of the lumen, and the lumen can also include a second bend of 30 degrees in the y-plane dimension at a second location along the length of the lumen.

A bend can, of course, be in more than one dimension, e.g., a bend that is at 15 degrees in the x-plane dimension and 30 degrees in the y-plane dimension. In one embodiment, the inner tube can be characterized as being of a corkscrew configuration. In another embodiment, the inner tube can be characterized as being S-shaped in configuration.

Embodiment 77. The insulated conduit of any of Embodiments 74-76, wherein the inner tube defines a second end, wherein the inner tube defines a second major axis at the second end of the inner tube.

Embodiment 78. The insulated conduit of Embodiment 77, wherein the second major axis does not intersect the first major axis.

Embodiment 79. The insulated conduit of Embodiment 77, wherein the second major axis intersects the first major axis.

Embodiment 80. The insulated conduit of Embodiment 77, wherein the second major axis is offset from the first major axis by a non-zero angle in at least one dimension.

Embodiment 81. The insulated conduit of Embodiment 80, wherein the second major axis is offset from the first major axis by a non-zero angle in at least two dimensions.

Embodiment 82. The insulated conduit of any of Embodiments 74-80, wherein at least one of the outer tube and the inner tube comprises a corrugated surface.

Embodiment 83. The insulated conduit of any of Embodiments 74-81, further comprising a spacer material disposed within the insulating space, the spacer material being disposed so as to maintain a separation between the inner tube and the outer tube. The spacer material is suitably a heat-resistant material, e.g., a ceramic. The spacer can be present as, e.g., a thread or yarn. In some embodiments, the spacer is in the form of a sleeve that is disposed between the inner and outer tubes. A sleeve can be woven, non-woven, or even helical in construction. In some embodiments, the spacer is in the form of a winding that is wound around the inner tube. The spacer is suitable a flexible material such that it can flex or otherwise accommodate bends in the inner tube.

Embodiment 84. The insulated conduit of Embodiment 83, wherein the spacer material comprises a ceramic.

Embodiment 85. The insulated conduit of any of Embodiments 83-84, wherein the spacer material is characterized as braided.

Embodiment 86. The insulated conduit of any of Embodiments 74-85, wherein the inner tube is characterized as having two bends, each in a different dimension.

Embodiment 87. The insulated conduit of any of Embodiments 74-86, wherein the sealing right is characterized as having a varying thickness.

Embodiment 88. The insulated conduit of Embodiment 87, wherein the thickness of the sealing ring increases in the direction of the first end of the inner tube and the first end of the outer tube.

Embodiment 89. The insulated conduit of any of Embodiments 87-88, wherein the sealing ring is characterized as having a V-shaped cross-section.

Embodiment 90. The insulated conduit of any of Embodiments 74-89, wherein the sealed insulating space defines a vacuum in the range of from about 10⁻⁵ to about 10⁻⁹ Torr.

Embodiment 91. The insulated conduit of any of Embodiments 74-90, wherein the sealed insulating space defines a vacuum in the range of from about 10⁻⁶ to about 10⁻⁸ Torr.

Embodiment 92. The insulated conduit of any of Embodiments 74-91, wherein the lumen of the inner tube defines a diameter in the range of from about 5 mm to about 20 cm.

Embodiment 93. The insulated conduit of Embodiment 92, wherein the lumen of the inner tube defines a diameter in the range of from about 10 mm to about 5 cm.

Embodiment 94. A method, comprising communicating a fluid through the lumen of an insulated conduit according to any of Embodiments 74-93.

Embodiment 95. The method of Embodiment 94, wherein the fluid defines a temperature of less than about 0 deg. C.

Embodiment 96. The method of Embodiment 94, wherein the fluid defines a temperature of greater than about 50 deg. C.

Embodiment 97. The method of any of Embodiments 94-96, wherein the fluid experiences a temperature loss of less than about 20 deg. C. during communication through the conduit.

Embodiment 98. The method of Embodiment 97, wherein the fluid experiences a temperature loss of less than about 10 deg. C. during communication through the conduit.

Embodiment 99. The method of Embodiment 98, wherein the fluid experiences a temperature loss of less than about 5 deg. C. during communication through the conduit.

Embodiment 100. A method, comprising: positioning an inner tube having a first end within an outer tube having a first end, so as to define an insulating space therebetween; positioning a spacer in the insulating space; sealing, to the inner tube and outer tube, a sealer ring having a first wall and a second wall so as to form a vent, the second wall of the sealer ring being disposed opposite the outer tube and the first wall of the sealer ring being disposed opposite the inner tube, the sealer ring being disposed between one or both of the first end of the outer tube and the first end of the inner tube and the other tube so as to seal the insulating space to provide an exit pathway for gas molecules from the space, the vent being sealable for maintaining a vacuum within the insulating space following evacuation of gas molecules through the vent, (a) the distance between the second wall of the sealer ring and the outer tube and/or (b) the distance between the first wall of the sealer ring and the and the outer tube being variable in a portion of the insulating space adjacent the vent such that gas molecules within the insulating space are directed towards the vent by the variable-distance portion of the first and second walls during the evacuation of the insulating space, the directing of the gas molecules by the variable-distance portion of the first and second walls imparting to the gas molecules a greater probability of egress from the insulating space than ingress, and the lumen of the inner tube comprising a first major axis at the first end of the inner tube

Embodiment 101. The method of Embodiment 100, the lumen comprising a bend, measured relative to the first major axis of from about 1 to about 180 degrees.

Embodiment 102. The method of Embodiment 100, further comprising bending the inner and outer tubes so as to form a bend in the lumen, the bending being performed under such conditions that the spacer maintains a spacing between the inner tube and outer tube.

Embodiment 103. The method of Embodiment 102, wherein the bending is performed such that the inner and outer tube are free of contact with one another.

Embodiment 104. An insulated conduit, comprising: a outer tube having a first end, the outer tube optionally comprising a corrugated region; an inner tube having a first end, the inner tube defining a lumen and the inner tube optionally comprising a corrugated region, the inner tube being disposed within the outer tube so as to define a insulating space between the first tube and the second tube, the conduit further comprising a vent defined by a seal between the outer tube and the inner tube, the vent being sealable for maintaining a vacuum within the insulating space following evacuation of gas molecules through the vent, the distance between the inner tube and the outer tube being variable in a portion of the insulating space adjacent the vent such that gas molecules within the insulating space are directed towards the vent by the variable-distance portion, the directing of the gas molecules by the variable-distance portion imparting to the gas molecules a greater probability of egress from the insulating space than ingress, and the lumen of the inner tube comprising a first major axis at the first end of the inner tube, and the lumen comprising a bend, measured relative to the first major axis, of from about 1 to about 180 degrees.

Embodiment 105. The insulated conduit of Embodiment 104, wherein the vent is formed by (a) a region of the outer tube that converges toward the inner tube, (b) a region of the inner tube that diverges toward the outer tube, or both (a) and (b). In some embodiments, the inner tube can comprise two or more segments.

Embodiment 106. The insulated conduit of any of Embodiments 104-105, wherein the inner tube comprises at least two curves in different planes.

Embodiment 107. The insulated conduit of any of Embodiments 104-106, wherein the inner tube defines a second end, wherein the inner tube defines a second major axis at the second end of the inner tube.

Embodiment 108. The insulated conduit of Embodiment 107, wherein the second major axis does not intersect the first major axis.

Embodiment 109. The insulated conduit of Embodiment 107, wherein the second major axis intersects the first major axis.

Embodiment 110. The insulated conduit of Embodiment 107, wherein the second major axis is offset from the first major axis by a non-zero angle in at least one dimension.

Embodiment 111. The insulated conduit of Embodiment 107, wherein the second major axis is offset from the first major axis by a non-zero angle in at least two dimensions.

Embodiment 112. The insulated conduit of any of Embodiments 104-111, further comprising a spacer material disposed within the insulating space, the spacer material being disposed so as to maintain a separation between the inner tube and the outer tube.

Embodiment 113. The insulated conduit of Embodiment 112, wherein the spacer material comprises a ceramic.

Embodiment 114. The insulated conduit of any of Embodiments 112-113, wherein the spacer material is characterized as braided.

Embodiment 115. The insulated conduit of any of Embodiments 104-114, wherein the inner tube is characterized as having two bends, each in a different dimension.

Embodiment 116. The insulated conduit of any of Embodiments 104-115, wherein the sealed insulating space defines a vacuum in the range of from about 10⁻⁵ to about 10⁻⁹ Torr.

Embodiment 117. The insulated conduit of Embodiment 116, wherein the sealed insulating space defines a vacuum in the range of from about 10⁻⁶ to about 10⁻⁸ Torr.

Embodiment 118. The insulated conduit of any of Embodiments 104-117, wherein the lumen of the inner tube defines a diameter in the range of from about 5 mm to about 20 cm.

Embodiment 119. The insulated conduit of Embodiment 118, wherein the lumen of the inner tube defines a diameter in the range of from about 10 mm to about 5 cm.

Embodiment 120. A method, comprising communicating a fluid through the lumen of an insulated conduit according to any of Embodiments 104-119.

Embodiment 121. The method of Embodiment 120, wherein the fluid defines a temperature of less than about 0 deg. C.

Embodiment 122. The method of Embodiment 121, wherein the fluid defines a temperature of greater than about 50 deg. C.

Embodiment 123. The method of any of Embodiments 120-122, wherein the fluid experiences a temperature loss of less than about 20 deg. C. during communication through the conduit.

Embodiment 124. The method of Embodiment 123, wherein the fluid experiences a temperature loss of less than about 10 deg. C. during communication through the conduit.

Embodiment 125. The method of Embodiment 124, wherein the fluid experiences a temperature loss of less than about 5 deg. C. during communication through the conduit.

Embodiment 126. A method, comprising: positioning an optionally corrugated inner tube having a first end within an optionally corrugated corrugated outer tube having a first end, so as to define an insulating space therebetween; (a) the outer tube comprising a region that converges toward the inner tube, (b) the inner tube comprising a region that diverges toward the outer tube, or both (a) and (b), optionally positioning a spacer material in the insulating space; sealing the outer tube and inner tube so as to form a vent, the vent being sealable for maintaining a vacuum within the insulating space following evacuation of gas molecules through the vent, the distance between the inner tube and the outer tube being variable in a portion of the insulating space adjacent the vent such that gas molecules within the insulating space are directed towards the vent by the variable-distance portion, the directing of the gas molecules by the variable-distance portion imparting to the gas molecules a greater probability of egress from the insulating space than ingress, and the lumen of the inner tube comprising a first major axis at the first end of the inner tube, and the lumen of the inner tube comprising a first major axis at the first end of the inner tube, the lumen comprising a bend, measured relative to the first major axis, of from about 1 to about 180 degrees.

Embodiment 127. The method of Embodiment 126, the lumen comprising a bend, measured relative to the first major axis of from about 1 to about 180 degrees.

Embodiment 128. The method of Embodiment 54, further comprising bending the inner and outer tubes so as to form a bend in the lumen, the bending being performed under such conditions that the spacer maintains a spacing between the inner tube and outer tube.

Embodiment 129. The method of Embodiment 55, wherein the bending is performed such that the inner and outer tube are free of contact with one another.

Embodiment 130. An insulated conduit, comprising: an outer tube having a first end and an inner tube having a first end, the inner tube defining a lumen, the first end of the inner tube and the first end of the outer tube being sealed to one another so as to define a insulating space between the first tube and the second tube, the distance between the inner and outer tubes being variable in a portion of the insulating space, and a vent in communication with the insulating space to provide an exit pathway for gas molecules from the insulating space, the vent located proximate to the variable distance portion of the insulating space such that gas molecules are guided towards the vent during evacuation of the insulating space to facilitate their egress from the insulating space, and the vent being sealable for maintaining a vacuum within the insulating space; the distance between the inner and outer tubes being variable in a portion of the insulating space adjacent the vent such that gas molecules within the insulating space are directed towards the vent by the variable-distance portion, the directing of the gas molecules by the variable-distance portion imparting to the gas molecules a greater probability of egress from the insulating space than ingress, and the lumen of the inner tube comprising a first major axis at the first end of the inner tube, and the lumen comprising a bend, measured relative to the first major axis of from about 1 to about 180 degrees.

Embodiment 131. The insulated conduit of Embodiment 57, wherein at least one of the inner tube and the outer tube comprises a corrugated region.

Embodiment 132. The insulated conduit of Embodiment 58, wherein the outer tube comprises a corrugated region.

Embodiment 133. The insulated conduit of Embodiment 58, wherein the outer tube is free of corrugations.

Embodiment 134. The insulated conduit of any of Embodiments 57-60, further comprising a spacing material disposed within the insulating space.

Embodiment 135. The insulated conduit of any of Embodiments 57-61, wherein the outer tube comprises a second end, wherein the inner tube comprises a second end, and wherein the second end of the inner tube and the second end of the outer tube are sealed.

It should be understood that in an insulated conduit according to the present disclosure, the inner and outer tubes can be sealed to one another so as to form a sealed insulated space therebetween, as described herein. In an insulated conduit according to the present disclosure, the inner and outer tubes can be sealed to a ring, e.g., as shown elsewhere herein.

The disclosed technology also includes communicating a fluid through an insulated conduit according to any Embodiments 130-135, or through an insulated conduit according to any other embodiment described herein.

Embodiment 136. An insulated conduit, comprising: an outer tube; an inner tube disposed within the outer tube, the inner tube defining a lumen, and the inner tube being disposed within the outer tube so as to define a insulating space between the inner tube and the outer tube; a sealer ring having a first wall and a second wall, the second wall being disposed opposite the outer tube and the first wall being disposed opposite the inner tube, the sealer ring comprising a ceramic material, the sealer ring being disposed between the outer tube and the inner tube so as to seal the insulating space to provide an exit pathway for gas molecules from the space, the lumen of the inner tube comprising a first major axis at a first end of the inner tube, and the lumen optionally comprising a bend, measured relative to the first major axis of from about 1 to about 180 degrees.

Embodiment 137. The insulated conduit of Embodiment 136, wherein the inner tube comprises two or more segments.

Embodiment 138. The insulated conduit of any of Embodiments 136-137, wherein the inner tube comprises at least two curves in different planes.

Embodiment 139. The insulated conduit of any of Embodiments 136-138, wherein the inner tube defines a second end, wherein the inner tube defines a second major axis at the second end of the inner tube.

Embodiment 140. The insulated conduit of Embodiment 139, wherein the second major axis does not intersect the first major axis.

Embodiment 141. The insulated conduit of Embodiment 139, wherein the second major axis intersects the first major axis.

Embodiment 142. The insulated conduit of Embodiment 139, wherein the second major axis is offset from the first major axis by a non-zero angle in at least one dimension.

Embodiment 143. The insulated conduit of Embodiment 139, wherein the second major axis is offset from the first major axis by a non-zero angle in at least two dimensions.

Embodiment 144. The insulated conduit of any of Embodiments 136-143, wherein at least one of the outer tube and the inner tube comprises a corrugated surface.

Embodiment 145. The insulated conduit of any of Embodiments 136-144, further comprising a spacer material disposed within the insulating space, the spacer material being disposed so as to maintain a separation between the inner tube and the outer tube.

Embodiment 146. The insulated conduit of Embodiment 145, wherein the spacer material comprises a ceramic.

Embodiment 147. The insulated conduit of any of Embodiments 145-146, wherein the spacer material is characterized as braided.

Embodiment 148. The insulated conduit of any of Embodiments 136-147, wherein the inner tube is characterized as having two bends, each in a different dimension.

Embodiment 149. The insulated conduit of any of Embodiments 136-148, wherein the sealing ring is characterized as having a varying thickness.

Embodiment 150. The insulated conduit of Embodiment 149, wherein the thickness of the sealing ring increases in the direction of the first end of the inner tube and the first end of the outer tube.

Embodiment 151. The insulated conduit of any of Embodiments 149-150, wherein the sealing ring is characterized as having a V-shaped cross-section.

Embodiment 152. The insulated conduit of any of Embodiments 136-151, wherein the sealed insulating space defines a vacuum in the range of from about 10⁻⁵ to about 10⁻⁹ Torr.

Embodiment 153. The insulated conduit of Embodiment 152, wherein the sealed insulating space defines a vacuum in the range of from about 10⁻⁶ to about 10⁻⁸ Torr.

Embodiment 154. The insulated conduit of any of Embodiments 136-153, wherein the lumen of the inner tube defines a diameter in the range of from about 5 mm to about 20 cm.

Embodiment 155. The insulated conduit of Embodiment 154, wherein the lumen of the inner tube defines a diameter in the range of from about 10 mm to about 5 cm.

Embodiment 156. A method, comprising communicating a fluid through the lumen of an insulated conduit according to any of Embodiments 136-155.

Embodiment 157. The method of Embodiment 156, wherein the fluid defines a temperature of less than about 0 deg. C.

Embodiment 158. The method of Embodiment 156, wherein the fluid defines a temperature of greater than about 50 deg. C.

Embodiment 159. The method of any of Embodiments 136-158, wherein the fluid experiences a temperature loss of less than about 20 deg. C. during communication through the conduit.

Embodiment 160. The method of Embodiment 159, wherein the fluid experiences a temperature loss of less than about 10 deg. C. during communication through the conduit.

Embodiment 161. The method of Embodiment 160, wherein the fluid experiences a temperature loss of less than about 5 deg. C. during communication through the conduit.

Embodiment 162. A method, comprising: positioning an inner tube within an outer so as to define an insulating space therebetween; optionally positioning a spacer in the insulating space; positioning a sealer ring having a first wall and a second wall so as to form a vent to the insulating space, the sealer ring comprising a ceramic material, the second wall of the sealer ring being disposed opposite the outer tube and the first wall of the sealer ring being disposed opposite the inner tube, the sealer ring being disposed so as to seal the insulating space to provide an exit pathway for gas molecules from the space, the vent being sealable for maintaining a vacuum within the insulating space following evacuation of gas molecules through the vent, and the lumen of the inner tube comprising a first major axis at the first end of the inner tube.

Embodiment 163. The method of Embodiment 162, the lumen comprising a bend, measured relative to the first major axis of from about 1 to about 180 degrees.

Embodiment 164. The method of Embodiment 162, further comprising bending the inner and outer tubes so as to form a bend in the lumen, the bending being performed under such conditions that the spacer maintains a spacing between the inner tube and outer tube.

Embodiment 165. The method of Embodiment 164, wherein the bending is performed such that the inner and outer tube are free of contact with one another.

Embodiment 166. An insulated module, comprising: a first boundary; a second boundary; the first boundary and the second boundary being disposed so as to define a insulating space between the first boundary and second boundary; a sealer element having a first wall and a second wall, the second wall being disposed opposite the second boundary and the first wall being disposed opposite the first boundary, the sealer element comprising a ceramic material, the sealer element being disposed between the first boundary and the second boundary so as to seal the insulating space to provide an exit pathway for gas molecules from the insulating space.

Embodiment 167. The insulated module of Embodiment 166, wherein the sealer element is affixed directly to at least one of the first boundary and the second boundary.

Embodiment 168. The insulated module of any of Embodiments 166-167, wherein the insulating space is evacuated.

Embodiment 169. The insulated module of any of Embodiments 166-168, wherein one or both of the first boundary and the second boundary comprises a metal.

Embodiment 170. The insulated module of Embodiment 169, wherein the metal comprises stainless steel.

Embodiment 171. The insulated module of any of Embodiments 166-170, further comprising a spacer material disposed within the insulating space, the spacer material being disposed so as to maintain a separation between the first boundary and the second boundary.

Embodiment 172. The insulated module of Embodiment 171, wherein the first boundary is characterized as a tube, wherein the second boundary is characterized as a tube, and wherein the first boundary is disposed within the second boundary.

Embodiment 173. The insulated module of Embodiment 172, wherein the first boundary is concentric with the second boundary.

Embodiment 174. The insulated module of Embodiment 173, wherein the sealer element is characterized as a ring.

Embodiment 175. The insulated module of any of Embodiments 166-174, wherein the sealer element has a constant cross section.

Embodiment 176. The insulated module of any of Embodiments 166-175, wherein the sealer element has a variable cross section.

Embodiment 177. The insulated module of Embodiment 176, wherein the sealer element has a V-shaped cross section.

Embodiment 178. The insulated module of Embodiment 177, wherein the sealer element has a U-shaped cross section.

Embodiment 179. The insulated module of any of Embodiments 166-178, wherein (a) the distance between the second wall of the sealer element and the second boundary tube and/or (b) the distance between the first wall of the sealer element and the and the first boundary tube being variable such that gas molecules within the insulating space are directed towards a vent formed by the sealer element by the variable-distance portion of the first and second walls during evacuation of the insulating space, the directing of the gas molecules by the variable-distance portion of the first and second walls imparting to the gas molecules a greater probability of egress from the insulating space than ingress.

Embodiment 180. A vacuum-insulated article, comprising: a first wall having a first thermal conductivity; a second wall having a second thermal conductivity; a first sealed insulating space formed between the first wall and the second wall, the insulating space defining therein a region of reduced pressure, the first sealed insulating space being at least partially defined by a bridge material that has a thermal conductivity that is less than the first thermal conductivity and the second thermal conductivity; optionally, a reflective material disposed within the first sealed insulating space, the reflective material optionally comprising boron nitride.

Embodiment 181. The article of Embodiment 180, further comprising a first vent communicating with the first insulating space to provide an exit pathway for gas molecules from the first insulating space, the first vent being sealable for maintaining a first vacuum within the first insulating space following evacuation of gas molecules through the first vent.

Embodiment 182. The article of any of Embodiments 180-181, wherein the thermal conductivity of the bridge material is less than 50% of the lesser of the first thermal conductivity and the second thermal conductivity.

Embodiment 183. The article of Embodiment 182, wherein the thermal conductivity of the bridge material is less than 10% of the lesser of the first thermal conductivity and the second thermal conductivity.

Embodiment 184. The article of Embodiment 183, wherein the thermal conductivity of the bridge material is less than 1% of the lesser of the first thermal conductivity and the second thermal conductivity.

Embodiment 185. An article, comprising: (a) an outer wall; (b) an inner wall; (c) a first sealed insulating space formed between the outer wall and the inner wall, at least one of the outer and inner walls having a sloped region that slopes toward the other wall, the sloped region at least partially defining the first sealed insulating space, the at least one wall having the sloped region further comprising a joint land connected to and extending from the sloped region, and the joint land forming a non-zero angle with the sloped region.

The first sealed insulating space is suitably at a reduced pressure; suitable such pressures are provided elsewhere herein.

As described herein, the inner wall can flare toward the outer wall and/or the outer wall can flare/converge toward the inner wall. (Exemplary articles are shown in, e.g., FIGS. 20-22 and the related description of those FIGs.) The non-zero angle can be, e.g., from more than 0 to less than +180 degrees (relative to the sloped portion), or less than 0 to less than −180 degrees (relative to the sloped portion). The non-zero angle can be, e.g., more than 0 to about +45 degrees, or less than 0 to about −45 degrees. The joint land of a first wall can extend in a direction that is parallel to a surface of the second wall, though this is not a requirement.

Embodiment 186. The article of Embodiment 185, wherein the outer wall and inner wall and joined to one another along at least a portion of the joint land.

Embodiment 187. The article of any of Embodiments 185-186, wherein the outer wall is tubular, wherein the inner wall is tubular, wherein the inner wall defines a central major axis, where in the sloped region of the outer wall defines a first distance along the central major axis, and wherein the joint land defines a second distance along the central major axis.

Embodiment 188. The article of Embodiment 187, wherein the ratio of the first distance to the second distance is from 10:1 to 1:10.

Embodiment 189. The article of Embodiment 188, wherein the ratio of the first distance to the second distance is from 5:1 to 1:5. In some embodiments, the first distance is greater than the second distance. In some embodiments, the first distance is less than the second distance. In some embodiments, the first and second distances are equal to one another.

The disclosed devices can be used in a variety of applications. As one example, a device according to the present disclosure can be used as a sprayer. A device according to the present disclosure can be configured as a nozzle, e.g., a nozzle used in a sprayer. A device can include a nozzle (e.g., a conical nozzle), and can also include a diffuser.

1. A vacuum-insulated article, comprising:
a first wall having a first thermal conductivity;
a second wall having a second thermal conductivity;
a first sealed insulating space formed between the first wall and the second wall, the insulating space defining therein a region of reduced pressure,
the first sealed insulating space being at least partially defined by a bridge material that has a thermal conductivity that is less than the first thermal conductivity and the second thermal conductivity;
optionally, a reflective material disposed within the first sealed insulating space, the reflective material optionally comprising boron nitride.

2. The article of claim 1, further comprising a first vent communicating with the first insulating space to provide an exit pathway for gas molecules from the first insulating space, the first vent being sealable for maintaining a first vacuum within the first insulating space following evacuation of gas molecules through the first vent.

3. The article of claim 1, wherein the thermal conductivity of the bridge material is less than 50% of the lesser of the first thermal conductivity and the second thermal conductivity.

4. The article of claim 3, wherein the thermal conductivity of the bridge material is less than 10% of the lesser of the first thermal conductivity and the second thermal conductivity.

5. (canceled)

6. An article, comprising: (a) an outer wall; (b) an inner wall; (c) a first sealed insulating space formed between the outer wall and the inner wall,
at least one of the outer and inner walls having a sloped region that slopes toward the other wall, the sloped region at least partially defining the first sealed insulating space the at least one wall having the sloped region further comprising a joint land connected to and extending from the sloped region, and the joint land forming a non-zero angle with the sloped region.

7. The article of claim 6, wherein the outer wall and inner wall and joined to one another along at least a portion of the joint land.

8. The article of claim 6, wherein the outer wall is tubular, wherein the inner wall is tubular, wherein the inner wall defines a central major axis, wherein the sloped region defines a first distance along the central major axis, and wherein the joint land defines a second distance along the central major axis.

9. (canceled)

10. A vacuum-insulated article, comprising:
a first wall and a second wall;
a first sealed insulating space formed between the first wall and the second wall,
the insulating space defining therein a region of reduced pressure;
a first vent communicating with the first insulating space to provide an exit pathway for gas molecules from the first insulating space, the first vent being sealable for maintaining a first vacuum within the first insulating space following evacuation of gas molecules through the first vent;
a first seal sealing the first insulating space at the first vent; and
at least one portion of a reflective material having a surface, the at least one portion of reflective material being disposed within the insulating space,
the surface of the reflective material comprising boron nitride.

11. (canceled)

12. (canceled)

13. (canceled)

14. The article of claim 10, further comprising a portion of a metallic sheeting material disposed within the insulating space.

15. The article of claim 10, wherein the reflective material comprises a ceramic fiber.

16. The article of claim 10, wherein the reflective material comprises alumina, silica, or both.

17. (canceled)

18. The article of claim 14, wherein the metallic sheeting material is disposed between at least two portions of reflective material.

19. The article of claim 10, wherein the reflective material is disposed between at least two portions of metallic sheeting material.

20. (canceled)

21. (canceled)

22. (canceled)

23. The article of claim 10, further comprising a third wall disposed such that the second wall is between the first and third walls.

24. The article of claim 23, further comprising a second insulating space disposed between the second and third walls and further comprising a portion of reflective material disposed within the second insulating space, the surface of the reflective material comprising boron nitride.

25. (canceled)

26. An article, comprising
first and second walls defining a sealed vacuum space disposed therebetween; and
at least one portion of a reflective material disposed within the sealed vacuum space,
the surface of the reflective material comprising boron nitride.

27. (canceled)

28. (canceled)

29. (canceled)

30. The article of claim 26, further comprising a metallic sheeting material disposed adjacent to the first wall, disposed adjacent to the second wall, or both.

31. The article of claim 26, further comprising a third wall disposed such that the second wall is between the first and third walls, further comprising a second insulating space disposed between the second and third walls, and further comprising a portion of the reflective material disposed within the second insulating space.

32. (canceled)

33. (canceled)

34. (canceled)

35. (canceled)

36. (canceled)

37. (canceled)

38. (canceled)

39. (canceled)

40. (canceled)

41. A vacuum-insulated vessel, comprising:
a first wall and a second wall defining a first insulating space of reduced pressure disposed between the first and second walls;
the second wall enclosing the first wall and the first wall enclosing and defining a storage volume;
a first conduit disposed so as to place the storage volume into fluid communication with the environment exterior to the vessel; and
a first vent communicating with the first insulating space to provide an exit pathway for gas molecules from the first insulating space, the first vent being sealable for maintaining a first vacuum within the first insulating space following evacuation of gas molecules through the first vent;
a first seal sealing the first insulating space at the first vent; and
at least one portion of reflective material disposed within the first insulating space,
the surface of the reflective material comprising boron nitride.

42. The vessel of claim 41, wherein at least one of the first and second walls comprises a curvilinear region.

43. (canceled)

44. (canceled)

45. The vessel of claim 41, wherein the first conduit comprises a first conduit wall and a second conduit wall, the first and second conduit walls defining therebetween an insulating conduit space of reduced pressure.

46. The vessel of claim 45, wherein the first conduit comprises a first vent communicating with the insulating conduit space so as to provide an exit pathway for gas molecules from the insulating conduit space, the first vent being sealable for maintaining a first vacuum within the insulating conduit space following evacuation of gas molecules through the first vent, the first conduit further comprising a first seal sealing the first insulating space at the first vent.

47. The vessel of claim 41, further comprising a baffle wall, the baffle wall being disposed within the first wall of the vessel, the baffle wall at least partially enclosing the storage volume, and the baffle wall and the first wall of the vessel defining a spillover volume therebetween, the spillover volume being capable of fluid communication with the storage volume.

48. (canceled)

49. (canceled)

50. (canceled)

51. (canceled)

52. (canceled)

53. (canceled)

54. (canceled)

55. (canceled)

56. (canceled)

57. (canceled)

58. (canceled)

59. (canceled)

60. (canceled)

61. (canceled)

62. (canceled)
